(19) United States
(12) Patent Application Publication
(10) Pub. No.: US 2012/0320018 A1
(43) Pub. Date: Dec. 20, 2012

(54) LIQUID-CRYSTAL PANEL DRIVE METHOD AND LIQUID-CRYSTAL DISPLAY DEVICE

(75) Inventors: Kohji Saitoh, Osaka-shi (JP); Masami Ozaki, Osaka-shi (JP)

(73) Assignee: Sharp Kabushiki Kaisha, Osaka-shi, Osaka (JP)

(21) Appl. No.: 13/580,070

(22) PCT Filed: Nov. 8, 2010
(86) PCT No.: PCT/JP2010/069852

§ 371 Date: Aug. 20, 2012

(30) Foreign Application Priority Data
Feb. 25, 2010 (JP) 2010-040888

(51) Int. Cl. G09G 3/36; G09G 5/00

(52) U.S. Cl. 345/209; 345/94

(57) ABSTRACT

A liquid crystal display device (1) in accordance with the present invention includes a first common electrode (11) and a second common electrode (12) in each pixel region of a display panel. The device (1) further includes delay circuit (A and B) for delaying the timings of polarity reversals of a first common electrode signal and a second common electrode signal which are respectively input to the first common electrode (11) and the second common electrode (12), said delaying being performed when the first common electrode signal and the second common electrode signal are subjected to respective polarity reversals in each horizontal scan period. The present invention thus provides a liquid crystal display device which, in a display device with wide viewing angle characteristics, lowers peak inrush current which is generated when the common electrode signal (common electrode voltage) is subjected to a polarity reversal.

### REFERENCE TO RELATED APPLICATIONS

This application is a national stage application under 35 USC 371 of International Application No. PCT/JP2010/069852, filed Nov. 8, 2010, which claims the priority of Japanese Patent Application No. 2010-040888, filed Feb. 25, 2010, the entire contents of which are incorporated herein by reference.

### FIELD OF THE INVENTION

The present invention relates to a method of driving an A.C.-driven liquid crystal panel and also to a liquid crystal display device incorporating the liquid crystal panel.

### BACKGROUND OF THE INVENTION

A typical driving method for liquid crystal panels is A.C. drive whereby the level of a data signal voltage which is outputted from a source driver and applied to a pixel electrode and the level of a common electrode voltage which is outputted from a common electrode signal generating circuit and applied to a common electrode are subjected to respective polarity reversals at certain fixed intervals. A.C. drive however has a problem that inrush current is generated and flows into a liquid crystal capacitor when the polarities are reversed.

In liquid crystal panels, such as large liquid crystal panels and high-resolution liquid crystal panels, which place a heavy load on the circuit configuration which outputs data signal voltages and a common electrode voltage, the inrush current is lowered by providing multiple source drivers and reversing the polarity at a different timing of each driver.

As an example, Patent Literature 1 describes an arrangement in which one liquid crystal panel is driven by multiple sets of source drivers and gate drivers. According to the arrangement, a liquid crystal panel is divided into at least two segments which are driven separately. The drive voltages applied across the segments of the liquid crystal panel are subjected to respective polarity reversals at deliberately different timings from one segment to the other. The arrangement achieves small inrush current (rush current) which flows into a liquid crystal panel capacitor, when compared with an arrangement in which all the bias voltages applied across pixels are subjected to respective polarity reversals at once.
Japanese Patent Application Publication, Tokukaihei, No. 5-249925A (Published Sep. 28, 1993)

### SUMMARY OF THE INVENTION

Nevertheless, this conventional arrangement is still short of sufficiently lowering the inrush current. In addition, the arrangement is not applicable to liquid crystal panels which include one source driver and one gate driver. Further lowering of inrush current is required.

The inventors of the present invention have focused on the fact that inrush current flows in a COM signal line when a COM signal is reversed (i.e., when a COM voltage is subjected to a polarity reversal) and found that an improved COM signal reversing mechanism can further lower the inrush current.

In view of these problems, it is an object of the present invention to provide a liquid crystal display device which exhibits a smaller transient inrush current value when the COM signal (COM voltage) is subjected to a polarity reversal.

In other words, a liquid crystal display device in accordance with the present invention, to address the problems, includes: an active matrix substrate on which a plurality of data signal lines and a plurality of scan signal lines which intersect with the plurality of data signal lines are provided, and a plurality of active elements and a plurality of pixel electrodes are provided at respective intersections of the plurality of data signal lines and the plurality of scan signal lines; a counter substrate provided opposite the active matrix substrate; a plurality of common electrodes provided on the active matrix substrate or the counter substrate, each of the plurality of common electrodes being made up of a first common electrode and a second common electrode, each of the plurality of pixel electrodes having (a) a region facing the first common electrode and (b) a region facing the second common electrode, the second common electrode being different from the first common electrode; a liquid crystal layer provided between the active matrix substrate and the counter substrate; first common electrode voltage application means for applying a first common electrode voltage to the first common electrode; second common electrode voltage application means for applying a second common electrode voltage to the second common electrode, the second common electrode voltage being different from the first common electrode voltage; and control means for controlling (i) the first common electrode voltage application means to apply the first common electrode voltage to the first common electrode so that the first common electrode voltage is subjected to a polarity reversal for each certain time period and (ii) the second common electrode voltage application means to apply the second common electrode voltage to the second common electrode so that the second common electrode voltage is subjected to a polarity reversal for each certain time period, said control means carrying out control so that a time difference is secured, in a given time period, at least one of: (1) between (a) a rising edge of a polarity reversal of a first common electrode voltage and (b) a rising edge of a polarity reversal of a second common electrode voltage, and (2) between (c) a falling edge of a polarity reversal of the first common electrode voltage and (d) a falling edge of a polarity reversal of the second common electrode voltage, where the rising edge of the polarity reversal indicates a time point at which the first or second common electrode voltage starts to rise from a first voltage to a second voltage which is larger than the first voltage, and the falling edge of the polarity reversal indicates a time point at which the first or second common electrode voltage starts to fall from a third voltage to a fourth voltage which is smaller than the third voltage.

According to the arrangement, a liquid crystal display device in accordance with the present invention can provide a liquid crystal display device which exhibits a smaller transient inrush current value when the COM signal (COM voltage) is subjected to a polarity reversal. The following description will discuss a case where the plurality of common electrodes are provided on the counter substrate, as an example.

First, the liquid crystal display device in accordance with the present invention is arranged so that each pixel electrode includes a region facing a first one of the plurality of common electrodes across a liquid crystal layer and a region facing a second one of the plurality of common electrodes across the liquid crystal layer, the second common electrode being different from the first common electrode and also that different common electrode voltages are applied to the first and second common electrodes. Accordingly, each pixel electrode includes at least a first region facing the first common electrode across the liquid crystal layer and a second region facing the second common electrode across the liquid crystal layer. When the liquid crystal display device is driven, the first common electrode voltage is applied to the first common electrode, and the second common electrode voltage is applied to the second common electrode. Since the first and second common electrode voltages have different voltage values as early described, the voltage applied across the liquid crystal layer in the first region, that is, the liquid crystal layer interposed between the first region of the pixel electrode and the first common electrode can be made to differ from the voltage applied across the liquid crystal layer in the second region, that is, the liquid crystal layer interposed between the second region of the pixel electrode and the second common electrode, or vice versa.

Furthermore, the liquid crystal display device has V-T characteristics that are in accordance with variable transmittances of the pixel regions averaged over the entire pixel. Display quality is hence improved for intermediate grayscale levels when the display screen of the liquid crystal display device is viewed from an oblique angle. In other words, the liquid crystal display device has improved viewing angle characteristics.

Viewing angle is increased in a case where the amplitude of either the first common electrode voltage (COM1) applied to the first common electrode or the second common electrode voltage (COM2) applied to the second common electrode is increased in excess of the amplitude of the conventional common electrode voltage (COM). This arrangement however also leads to a problem of increased inrush current occurring in reversing the COM signal. For example, the COM amplitude is 5 Vpp in a conventional arrangement (1), whereas in an arrangement (2) which includes COM1 and COM2, the COM1 amplitude is 4 Vpp, and the COM2 amplitude is 8.5 Vpp. The electric current needed to reverse the COM signal is given by the following equation:

Electric Current=f×C×Vpp,

where f is a reversal frequency, C is a liquid crystal capacitance, and Vpp is a COM amplitude. Hence,

Electric Current Needed for Arrangement(1)=f×C×5=5fC

Electric Current Needed for Arrangement(2)=f×(C/2)×4+f×(C/2)×8.5=6.25fC

These results show that the electric current needed in reversing the COM signal is greater in the arrangement (2). In addition, to prepare for the generation of this inconvenient inrush current, the system end needs to have a current supplying capability that is sufficient in view of the value of the inrush current to prevent a flow of inrush current from shutting down power supply. In other words, costly components have to be used in designing a system-end power supply to prepare for the inrush current. According to the present invention, however, there is provided control means for controlling to provide, upon at least either rising or falling edge of polarity reversals of the first and second common electrode voltages in a given horizontal scan period, a time difference between the timing at which the first common electrode voltage is subjected to a polarity reversal and the timing at which the second common electrode voltage is subjected to a polarity reversal. Accordingly, not all the first and second common electrode voltages are subjected to respective polarity reversals at once; the voltages are reversed at different timings. This time difference disperses the peaks (instantaneous values) of a current waveform along the time axis and prevents the peaks from being concentrated at any point in time.

Thus, in a liquid crystal display device, having wide viewing angle characteristics, in which a plurality of subpixels are formed by providing a plurality of common electrodes to face pixel electrodes, it is possible to suppress increases in the electric current needed in polarity reversal of the common electrode voltages.

In addition, this arrangement of the present invention allows generation of inconvenient inrush current to be held down in this manner, and therefore eliminates the need to use costly components in designing a system-end power supply.

In other words, it is possible to provide, at low cost, a liquid crystal display device, having wide viewing angle characteristics, which achieves low power consumption by restraining generation of inconvenient inrush current.

Therefore, according to the arrangement of the present invention, it is possible to realize wide viewing angle characteristics and also to lower the transient inrush current value (peak value) which is a problem that occurs in a conventional arrangement when the common electrode voltage is subjected to a polarity reversal.

Note that a polarity is a term that describes, in a relative manner, the relationship between the electric potential of a common electrode and the electric potential of a source in a period in which a voltage is applied to a pixel electrode. The state in which the source potential level is relatively high as compared with the electric potential of the common electrode is described as being positive, whereas the state in which the source potential level is relatively low as compared with the electric potential of the common electrode is described as being negative.

Additional objects, features, and advantages of the invention will be more readily understood upon consideration of the following detailed description of the invention, taken in conjunction with the accompanying drawings.

As described in the foregoing, a liquid crystal display device in accordance with the present invention includes: an active matrix substrate on which a plurality of data signal lines and a plurality of scan signal lines which intersect with the plurality of data signal lines are provided, and a plurality of active elements and a plurality of pixel electrodes are provided at respective intersections of the plurality of data signal lines and the plurality of scan signal lines; a counter substrate provided opposite the active matrix substrate; a plurality of common electrodes provided on the active matrix substrate or the counter substrate, each of the plurality of common electrodes being made up of a first common electrode and a second common electrode, each of the plurality of pixel electrodes having (a) a region facing the first common electrode and (b) a region facing the second common electrode, the second common electrode being different from the first common electrode; a liquid crystal layer provided between the active matrix substrate and the counter substrate; first common electrode voltage application means for applying a first common electrode voltage to the first common electrode; second common electrode voltage application means for applying a second common electrode voltage to the second common electrode, the second common electrode voltage being different from the first common electrode voltage; and control means for controlling (i) the first common electrode voltage application means to apply the first common electrode voltage to the first common electrode so that the first common electrode voltage is subjected to a polarity reversal for each certain time period and (ii) the second common electrode voltage application means to apply the second common electrode voltage to the second common electrode so that the second common electrode voltage is subjected to a polarity reversal for each certain time period, said control means carrying out control so that a time difference is secured, in a given time period, at least one of: (1) between (a) a rising edge of a polarity reversal of a first common electrode voltage and (b) a rising edge of a polarity reversal of a second common electrode voltage, and (2) between (c) a falling edge of a polarity reversal of the first common electrode voltage and (d) a falling edge of a polarity reversal of the second common electrode voltage, where the rising edge of the polarity reversal indicates a time point at which the first or second common electrode voltage starts to rise from a first voltage to a second voltage which is larger than the first voltage, and the falling edge of the polarity reversal indicates a time point at which the first or second common electrode voltage starts to fall from a third voltage to a fourth voltage which is smaller than the third voltage.

Thus, in a liquid crystal display device in which each pixel electrode includes a region facing a first one of the plurality of common electrodes across a liquid crystal layer and a region facing a second one of the plurality of common electrodes across the liquid crystal layer, the second common electrode being different from the first common electrode, it is possible to provide a liquid crystal display device which exhibits a smaller transient inrush current value (peak value) when the common electrode voltages are subjected to respective polarity reversals.

### BRIEF DESCRIPTION OF THE DRAWINGS

FIG. 1 is a block diagram of a liquid crystal display device in accordance with an embodiment of the present invention.

FIG. 2 is a cross-sectional view of a substrate structure constituting a pixel array for the liquid crystal display device shown in FIG. 1.

FIG. 3 is a plan view partially illustrating a display panel for the liquid crystal display device shown in FIG. 1.

FIG. 4 is a plan view of a surface of a counter substrate provided in the display panel for the liquid crystal display device shown in FIG. 1. Common electrodes will be formed on the surface.

FIG. 5 is (i) a timing chart of signals applied to the respective first and second common electrodes ((a) of FIG. 5) and (ii) current waveform diagrams corresponding to the timing chart ((b) in FIG. 5).

FIG. 6 is (i) a timing chart of signals applied to the respective first and second common electrodes ((a) in FIG. 6) and (ii) current waveform diagrams corresponding to the timing chart ((b) in FIG. 6).

FIG. 7 is (i) a timing chart of signals applied to the respective first and second common electrodes ((a) in FIG. 7) and (ii) current waveform diagrams corresponding to the timing chart ((b) in FIG. 7).

FIG. 8 is (i) a timing chart of signals applied to the respective first and second common electrodes ((a) in FIG. 8) and (ii) current waveform diagrams corresponding to the timing chart ((b) in FIG. 8).

FIG. 9 is (i) a timing chart of signals applied to the respective first and second common electrodes ((a) in FIG. 9) and (ii) current waveform diagrams corresponding to the timing chart ((b) in FIG. 9).

FIG. 10 is (i) a timing chart of signals applied to the respective first and second common electrodes ((a) in FIG. 10) and (ii) current waveform diagrams corresponding to the timing chart ((b) in FIG. 10).

FIG. 11 is (i) a timing chart of signals applied to the respective first and second common electrodes ((a) in FIG. 11) and (ii) current waveform diagrams corresponding to the timing chart ((b) in FIG. 11).

FIG. 12 is (i) a timing chart of signals applied to the respective first and second common electrodes ((a) in FIG. 12) and (ii) current waveform diagrams corresponding to the timing chart ((b) in FIG. 12).

FIG. 13 shows circuit blocks for a comparative circuit configuration.

FIG. 14 is a timing chart of signals applied to the respective first and second common electrodes.

FIG. 15 is a drawing showing, using a part of FIG. 1, a circuit configuration with which FIG. 14 is embodied.

FIG. 16 is a timing chart showing a circuit configuration and its effect using a part of FIG. 1.

FIG. 17, relating to another embodiment of a liquid crystal display device in accordance with the present invention, is (i) a timing chart of signals applied to the respective first and second common electrodes on a counter substrate provided in a display panel of the liquid crystal display device ((a) in FIG. 17) and (ii) current waveform diagrams corresponding to the timing chart ((b) in FIG. 17).

FIG. 18, relating to another embodiment of a liquid crystal display device in accordance with the present invention, is (i) a timing chart of signals applied to the respective first and second common electrodes on a counter substrate provided in a display panel of the liquid crystal display device ((a) in FIG. 18) and (ii) current waveform diagrams corresponding to the timing chart ((b) in FIG. 18).

FIG. 19, relating to another embodiment of a liquid crystal display device in accordance with the present invention, is a timing chart of signals applied to the respective first and second common electrodes on a counter substrate provided in a display panel of the liquid crystal display device.

FIG. 20, relating to another embodiment of a liquid crystal display device in accordance with the present invention, is a timing chart of signals applied to the respective first and second common electrodes on a counter substrate provided in a display panel of the liquid crystal display device.

### DETAILED DESCRIPTION OF THE INVENTION

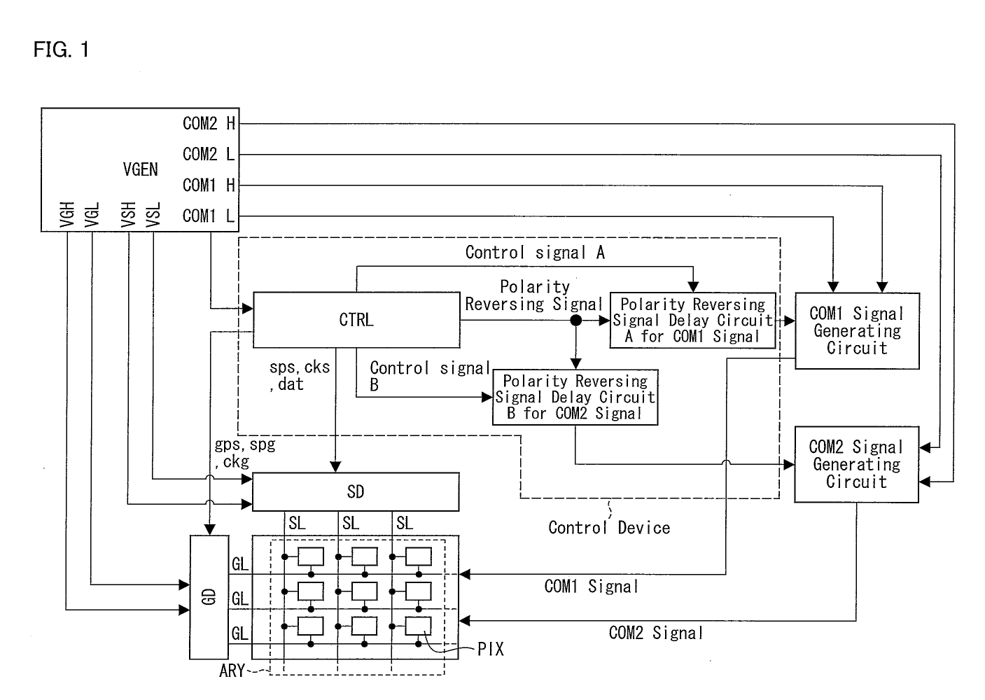

The following description will discuss an embodiment of a liquid crystal display device in accordance with the present invention in reference to FIGS. 1 through 12 and FIGS. 14 through 16.

FIG. 1 is a schematic block diagram illustrating an entire arrangement of a liquid crystal display device of active matrix type in accordance with Embodiment 1.

As is clear from FIG. 1, the liquid crystal display device 1 includes: (i) a display panel constituted by a pixel array ARY, a scan signal line drive circuit GD, and a data signal line drive circuit SD; (ii) a control device (control means) including a timing controller CTRL; and (iii) an external power supply circuit VGEN.

According to the pixel array ARY of the display panel, pixels PIX are provided, in a matrix manner, near intersections of a number of scan signal lines GL and a number of data signal lines SL with which the scan signal lines GL intersect. Each pixel PIX is connected to an adjoining one of the number of scan signal lines GL and to an adjoining one of the number of data signal lines SL.

The pixel array ARY, the data signal line drive circuit SD, and the scan signal line drive circuit GD are provided on a single substrate and driven in response to (i) a video signal dat, a clock signal cks, a start signal sps, a clock signal ckg, a start signal spg, and a plse width control signal gps, which are provided by the timing controller CTRL and (ii) various drive power sources supplied from the external power supply circuit VGEN.

The data signal line drive circuit SD samples an inputted video signal dat in synchronism with the clock signal cks and other timing signals. The video signal dat thus sampled is outputted, after being amplified, if necessary, to the data signal lines SL. The scan signal line drive circuit GD sequentially selects the scan signal lines GL in synchronism with the clock signal ckg and other timing signals, and controls switching elements in the respective pixels PIX to be turned on or off. This causes the video signal (data) dat, which has been outputted to the data signal lines SL, to be (i) written into the pixels PIX and (ii) retained in the pixels PIX.

In a case of a liquid crystal display device which carries out a color display using R (red), G (green), and B (blue) as primary colors, for example, three R, G, and B pixels PIX produces one (1) color.

The following description will discuss in detail how the pixel array ARY is configured in the display panel. For convenience, the scan signal line drive circuit GD and the data signal line drive circuit SD are omitted from the following description.

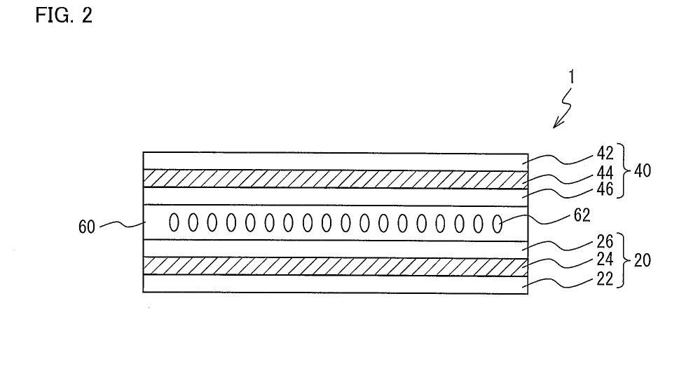

FIG. 2 is a cross-sectional view of a substrate structure constituting the pixel array ARY. The display panel of the liquid crystal display device 1 includes: (i) an active matrix substrate 20 constituted by pixel electrodes 24, an alignment film 26, an insulating substrate 22 on which the pixel electrodes 24 and the alignment film 26 are provided; (ii) a counter substrate 40 constituted by a common electrode 44, an alignment film 46, and an insulating substrate 42 on which the common electrode 44 and the alignment film 46 are provided; and (iii) a liquid crystal layer 60 provided between the active matrix substrate 20 and the counter substrate 40. The active matrix substrate 20 and the counter substrate 40 are each provided with a polarizer (not shown). The polarizers have respective polarization axes which meet a crossed Nicol relationship. The liquid crystal layer 60 has a substantially uniform thickness.

The pixels PIX (see FIG. 1) are delineated by the pixel electrodes 24.

Note that the liquid crystal display device 1 of Embodiment 1 operates in VA mode. The alignment films 26 and 46 are respective vertical alignment films. The liquid crystal layer 60 is of vertical alignment type. A “liquid crystal layer of vertical alignment type” refers to a liquid crystal layer in which liquid crystal molecules have their respective axes oriented (alternatively termed “axial alignment”) at about 85° or greater with respect to surfaces of the vertical alignment films 26 and 46. The liquid crystal molecules exhibit negative dielectric anisotropy and carry out a display in normally black mode in a combination with the polarizers which meet the crossed Nicol relationship. While no voltage is applied across the liquid crystal layer 60, the liquid crystal molecules 62 in the liquid crystal layer 60 are oriented substantially parallel to a normal to major surfaces of the alignment films 26 and 46. In contrast, while a voltage which is higher than a predetermined voltage is being applied across the liquid crystal layer 60, the liquid crystal molecules 62 in the liquid crystal layer 60 are oriented substantially parallel to the major surfaces of the alignment films 26 and 46. The active matrix substrate 20 and the counter substrate 40 include the alignment films 26 and 46, respectively, according to Embodiment 1. The present embodiment is not limited to this. Alternatively, at least one of the active matrix substrate 20 and the counter substrate 40 can be include a corresponding one of the alignment films 26 and 46. In view of stability of orientation, however, the active matrix substrate 20 and the counter substrate 40 preferably include the alignment films 26 and 46 respectively.

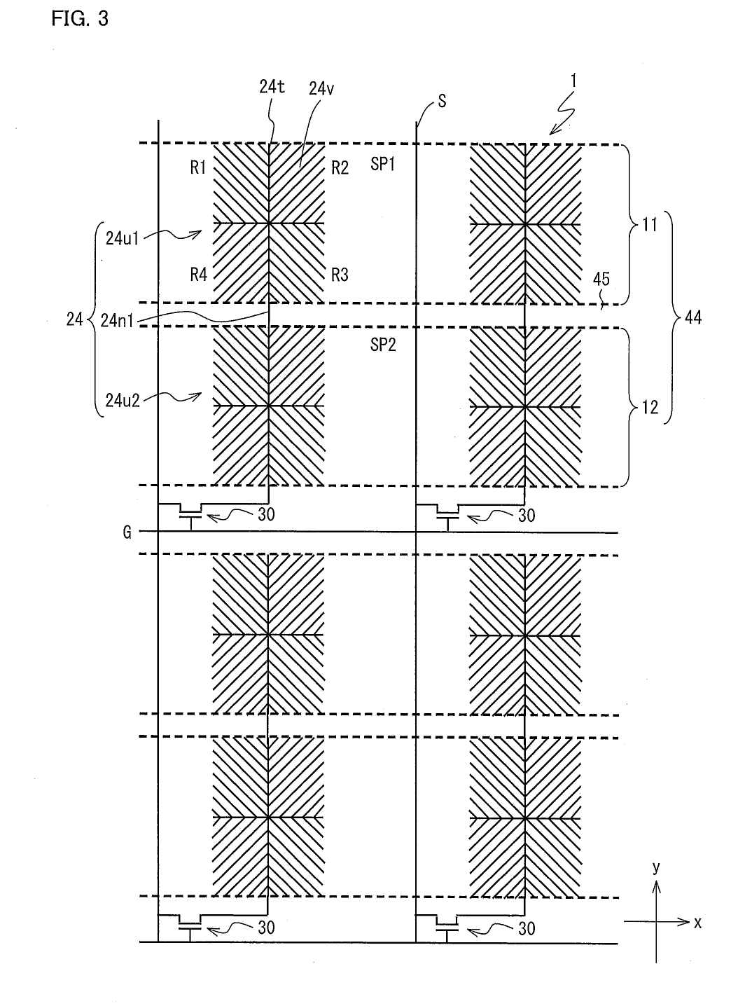

FIG. 3 is a plan view partially illustrating the display panel shown in FIG. 1. For convenience, the scan signal line drive circuit GD and the data signal line drive circuit SD are likewise omitted from FIG. 3.

According to the display panel of the liquid crystal display device 1, the gate wires GL extend in an x-direction and the source wires SL extend in a y-direction (see FIG. 3). Each TFT 30 is provided near a corresponding one of intersections of the gate wires GL and the source wires SL. FIG. 3 shows 2×2 pixels as a part of a pixel array.

As is clear from FIG. 3, each pixel electrode 24 includes unit sections 24u1 and 24u2 and a connecting section 24n1. The unit sections 24u1 and 24u2 are provided in a column direction (y-direction). The connecting section 24n1 connects the unit section 24u1 and the unit section 24u2 together, so that the unit section 24u1 and the unit section 24u2 have identical electric potentials. Note that FIG. 3 does not show all unit sections. According to the liquid crystal display device 1, six unit sections (2 in the x-direction×3 in the y-direction) are provided as a display unit displaying one (1) color.

The unit sections 24u1 and 24u2 have identical shapes. The shape of the unit section 24u1 will be specifically described below. Each of the unit sections 24u1 is made up of a cross-shaped axial section 24t and four stripe sections 24v which extend from the axial section 24t. The cross-shaped axial section 24t delineates four regions R1 through R4. The stripe sections 24v in the regions R1 and R3 extend with respective azimuths of 135° and 315°, and the stripe sections 24v in the regions R2 and R4 extend with respective azimuths of 45° and 225°, where the azimuth has, as a reference, a horizontal direction (left-to-right direction) of a display screen (page surface of FIG. 3) and is positive in a counterclockwise direction (when comparing a display surface to clock face, the 3 o'clock direction corresponds to an azimuth of 0°, and the azimuth increases counterclockwise). The unit sections 24u1 and 24u2 have a fish bone structure. Each of the unit sections 24u1 and 24u2 have dimensions of 45 μm×45 μm. The connecting section 24n1 has a length of 5 μm. The axial section 24t has a width of 4 μm. The stripe section 24v has a width and a pitch of 2.5 μm and 5.0 μm respectively.

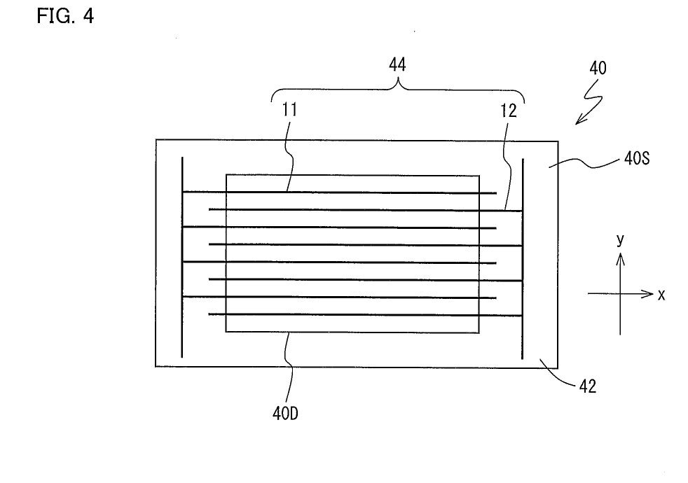

The common electrode 44 will be described below. FIG. 4 is a plan view illustrating a surface, of the counter substrate 40, on which the common electrode 44 is provided.

According to Embodiment 1, the common electrode 44 is made up of first common electrodes 11 and second common electrodes 12 which linearly extend on a display area 40D of the liquid crystal display device 1 so as to alternate in a row direction (x-directions) (see FIG. 4). Each of the linearly extending first and second common electrodes 11 and 12 can have a width (length in a y-direction) of, for example, 145 μm. A slit 45 can have a width of, for example, 5 μm.

The following description will discuss where the first and second common electrodes 11 and 12 overlap the pixel electrodes 24 (the unit sections 24u1 and 24u2 and the connecting section 24n) in reference to FIG. 3.

A first common electrode 11 and a second common electrode 12 are provided, as is clear from FIG. 3, so as to overlap with respective pixel electrodes 24 arranged in a corresponding row. Specifically, the first common electrode 11 and the unit section 24u1 in one of the pixel electrodes 24 are arranged to overlap each other, and the second common electrode 12 and the unit section 24u2 in the other of the pixel electrodes 24 are arranged to overlap each other. The first common electrode 11 and the second common electrode 12, which linearly extend in the row direction (x-direction), are alternated so that a linear slit 45 is secured between respective adjacent first and second common electrodes 11 and 12. This causes a pixel P delineated by the pixel electrode 24 to be made up of (i) a subpixel SP1 delineated by the overlapping of the unit section 24u1 and the first common electrode 11 and (ii) a subpixel SP2 delineated by the overlapping of the unit section 24u2 and the second common electrode 12. The unit sections 24u1 and 24u2 hence function as respective subpixel electrodes in the liquid crystal display device 1.

The first common electrode 11 and the second common electrode 12 are electrically isolated from each other, and receive respective different common electrode signals. In other words, the first common electrode 11 and the second common electrode 12 receive respective different common electrode voltages. The common electrode signals applied to the respective first and second common electrodes are generated by a common electrode signal application circuit provided in the external power supply circuit VGEN, via later described common electrode (COM) signal generating circuits (first common electrode voltage application means, second common electrode voltage application means).

Hereinafter, (i) a signal (voltage) to be applied to a first common electrode 11 is referred to as a first common electrode signal (first common electrode voltage), (ii) a signal (voltage) to be applied to a second common electrode 12 is referred to as a second common electrode signal (second common electrode voltage), (iii) the first common electrode signal can be referred to also as the COM1 signal, and (iv) the second common electrode signal can be referred to also as the COM2 signal.

The first common electrode signal is supplied to the first common electrode 11 via wiring in a frame area 40S provided on a left side of the display area 40D. The second common electrode signal is supplied to the second common electrode 12 via wiring in the frame area 40S provided on a right side of the display area 40D.

The first and second common electrode signals can be generated by an external circuit and then supplied to the liquid crystal display device 1 via respective COM terminals. Alternatively, the first and second common electrode signals can be generated by a driver.

While a voltage is being applied across the liquid crystal layer 60 (see FIG. 2), liquid crystal molecules 62 in each stripe section 24v of the liquid crystal layer 60 are oriented parallel to a direction in which the each stripe section 24v extends. In this situation, the fish bone structures of the unit sections 24u1 and 24u2 shown in FIG. 3 stabilize the orientations of the liquid crystal molecules 62 and form a liquid crystal domain in each of the regions R1 through R4.

Hereinafter, an orientation of the liquid crystal molecules at a center of a liquid crystal domain is referred to as a reference orientation direction. Also hereinafter, an azimuth component, of the reference orientation direction, which is headed from a backside to a foreside along major axes of the liquid crystal molecules (i.e., an azimuth component obtained by projecting the reference orientation direction onto the major surface of the alignment film 26 or the alignment film 46 which are shown in FIG. 2) is referred to as reference azimuth. The reference azimuth characterizes a corresponding liquid crystal domain, and viewing angle characteristics of the liquid crystal domain are dominantly affected by the reference azimuth. Specifically, the four reference orientation directions of the liquid crystal domains in the regions R1 through R4 are set so that a difference between respective two of the reference orientation directions is substantially equal to an integral multiple of 90°. Specifically, the reference azimuths of the liquid crystal domains in the regions R1 through R4 are 135°, 45°, 315°, and 225° respectively. Accordingly, symmetric viewing angle characteristics are realized.

As early described, the first common electrode signal is applied to the first common electrode 11, and the second common electrode signal is applied to the second common electrode 12 which is different from the first common electrode signal. The unit sections 24u1 and 24u2 of the pixel electrode 24 shown in FIG. 3 have identical electric potentials. Therefore, a voltage applied across the liquid crystal layer 60 (see FIG. 1) between the unit section 24u1 and the first common electrode 11 is different from a voltage applied across the liquid crystal layer 60 (see FIG. 1) between the unit section 24u2 and the second common electrode 12. This causes the subpixel SP1 to have a transmittance which is different from that of the subpixel SP2, during an intermediate grayscale-level display.

For ease of the following description, it is supposed that input signals are inputted which cause all pixels to have identical grayscale levels. For example, in a case where input signals are inputted which cause all pixels to have a maximum grayscale level, the entire screen displays white. It is further supposed that, in a case where a voltage of 5V is applied across the liquid crystal layer 60 (see FIG. 1), the pixels exhibit transmittances which correspond to the maximum grayscale level.

An electric potential of the common electrode, instead of that of the pixel electrode, is adjusted to improve excess brightness in the liquid crystal display device 1 of Embodiment 1.

The liquid crystal display device 1 of Embodiment 1 is arranged to control how to apply the first and second common electrode voltages to the first and second common electrodes, respectively (i.e., how to apply the first and second common electrode signals to the first and second common electrodes, respectively). Specifically, the liquid crystal display device 1 carries out the following control: a time difference is secured, in a given horizontal scan period, at least one of (1) between (a) a rising edge of a polarity reversal of a first common electrode voltage and (b) a rising edge of a polarity reversal of a second common electrode voltage and (2) between (c) a falling edge of a polarity reversal of the first common electrode voltage and (d) a falling edge of a polarity reversal of the second common electrode voltage. Note that (i) the first and second common electrode voltages (the first and second common electrode signals) are each subjected to a polarity (electric potential) reversal at integral multiples of a horizontal scan period, (ii) the rising edge of the polarity reversal indicates a time point at which the first or second common electrode voltage starts to rise from a first voltage to a second voltage which is larger than the first voltage, and (iii) the falling edge of the polarity reversal indicates a time point at which the first or second common electrode voltage starts to fall from a third voltage to a fourth voltage which is smaller than the third voltage.

The following description will discuss the feature arrangement, referring to the following eight example Patterns A through H.

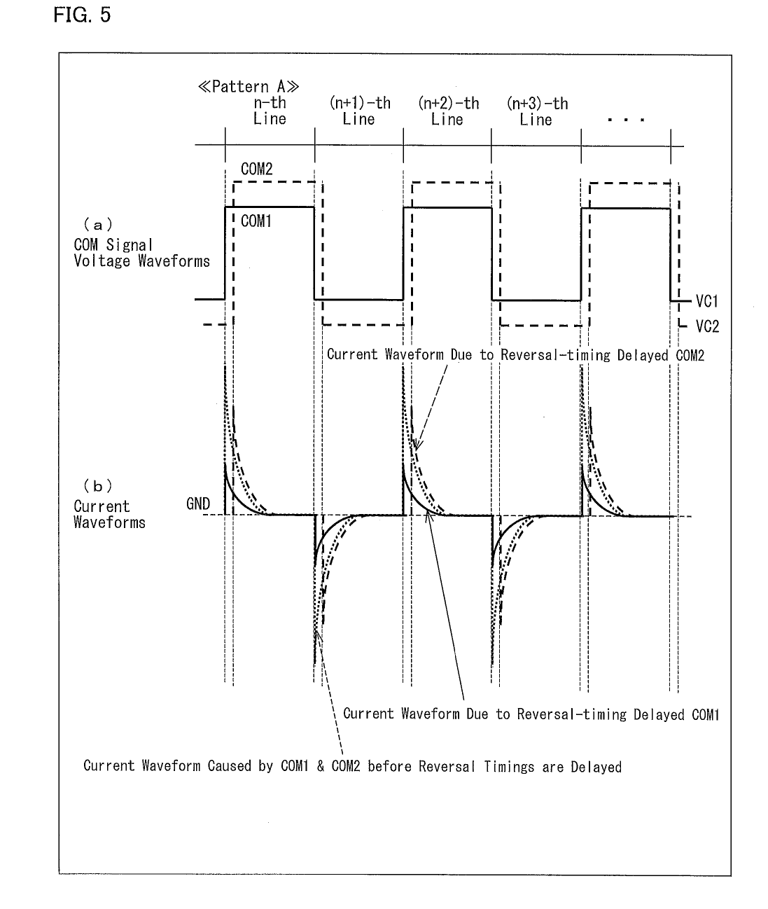

FIG. 5 shows (i) a timing chart of signals applied to the respective first and second common electrodes 11 and 12 in Pattern A ((a) of FIG. 5) and (ii) current waveform diagrams corresponding to the timing chart ((b) of FIG. 5).

In Pattern A, as shown in (a) of FIG. 5, (i) a first common electrode signal VC1 has an amplitude which is smaller than that of the second common electrode signal VC2 (ii) a timing of a polarity reversal of the second common electrode signal VC2 is always delayed with respect to a timing of a corresponding polarity reversal of the first common electrode signal VC1. According to Pattern A, (a) a timing of a polarity reversal of the second common electrode signal VC2 is delayed with respect to a timing of a polarity reversal of the first common electrode signal VC1, with regard to the time difference (1) and (b) a timing of a polarity reversal of the second common electrode signal VC2 likewise is delayed with respect to a timing of a polarity reversal of the first common electrode signal VC1, with regard to the time difference (2).

Note that the timing of the polarity reversal of the first common electrode signal VC1 is synchronized with a timing of a line inversion in Pattern A.

The current waveform diagram in (b) of FIG. 5 further shows, for comparison, a comparative current waveform obtained in a case where the first and second common electrode signals are simultaneously subjected to respective polarity reversals, as well as a current waveform corresponding to the timing chart of Pattern A. As is clear from (b) of FIG. 5, inrush currents are dispersed along a time axis by employing Pattern A in which a timing of a polarity reversal of the second common electrode signal VC2 is always delayed with respect to a timing of a polarity reversal of the first common electrode signal VC1. In other words, Pattern A is a driving method capable of holding down peak values (transient values) of the current waveform, as compared with those of a comparative current waveform.

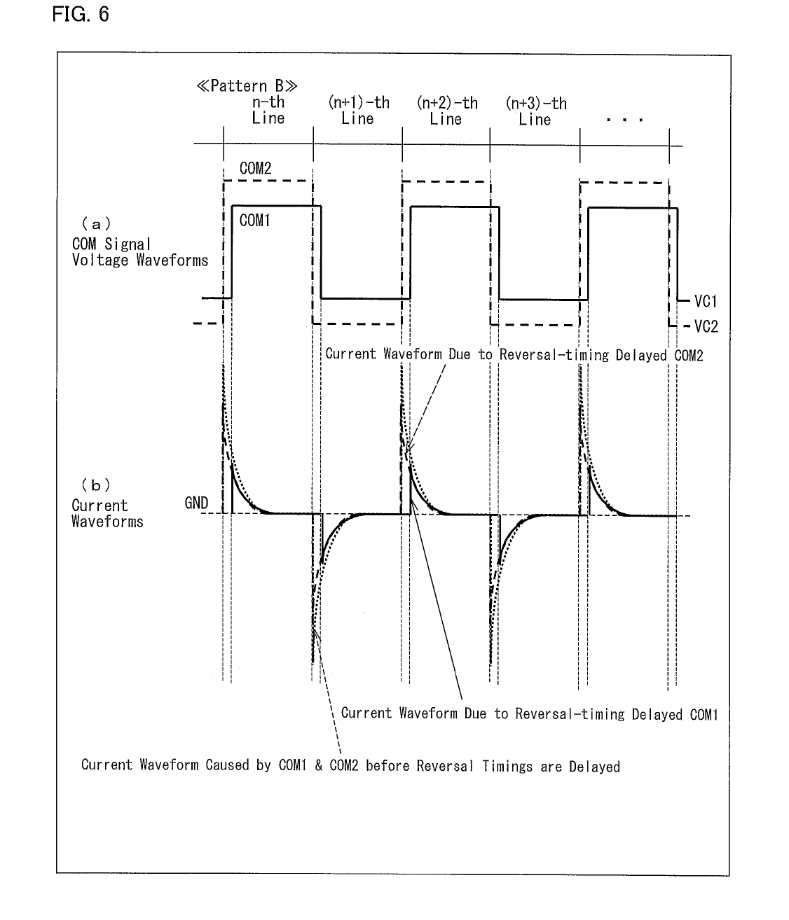

FIG. 6 shows (i) a timing chart of signals applied to the respective first and second common electrodes 11 and 12 in Pattern B ((a) of FIG. 6) and (ii) current waveform diagrams corresponding to the timing chart ((b) of FIG. 6).

In Pattern B, as shown in (a) of FIG. 6, (i) a first common electrode signal VC1 has an amplitude which is smaller than that of the second common electrode signal VC2, and (ii) a timing of a polarity reversal of the first common electrode signal VC1 is always delayed with respect to a timing of a corresponding polarity reversal of the second common electrode signal VC2. According to Pattern B, a timing of a polarity reversal of the first common electrode signal VC1 is delayed with respect to a timing of a polarity reversal of the second common electrode signal VC2 with regard to the time difference (1), and a timing of a polarity reversal of the first common electrode signal VC1 likewise is delayed with respect to a timing of a polarity reversal of the second common electrode signal VC2 with regard to the time difference (2).

Furthermore, the timing of the polarity reversal of the second common electrode signal VC2 is synchronized with a timing of a line inversion in Pattern B.

The current waveform diagram in (b) of FIG. 6 further shows the comparative current waveform shown in (b) of FIG. 5, as well as a current waveform corresponding to the timing chart of Pattern B. As is clear from (b) of FIG. 6 that an inrush current is dispersed along a time axis by employing Pattern B in which a timing of a polarity reversal of the first common electrode signal VC1 is always delayed with respect to a timing of a corresponding polarity reversal of the second common electrode signal VC2. In other words, Pattern B is a driving method capable of holding down peak values (transient values) of the current waveform as compared with a comparative circuit configuration.

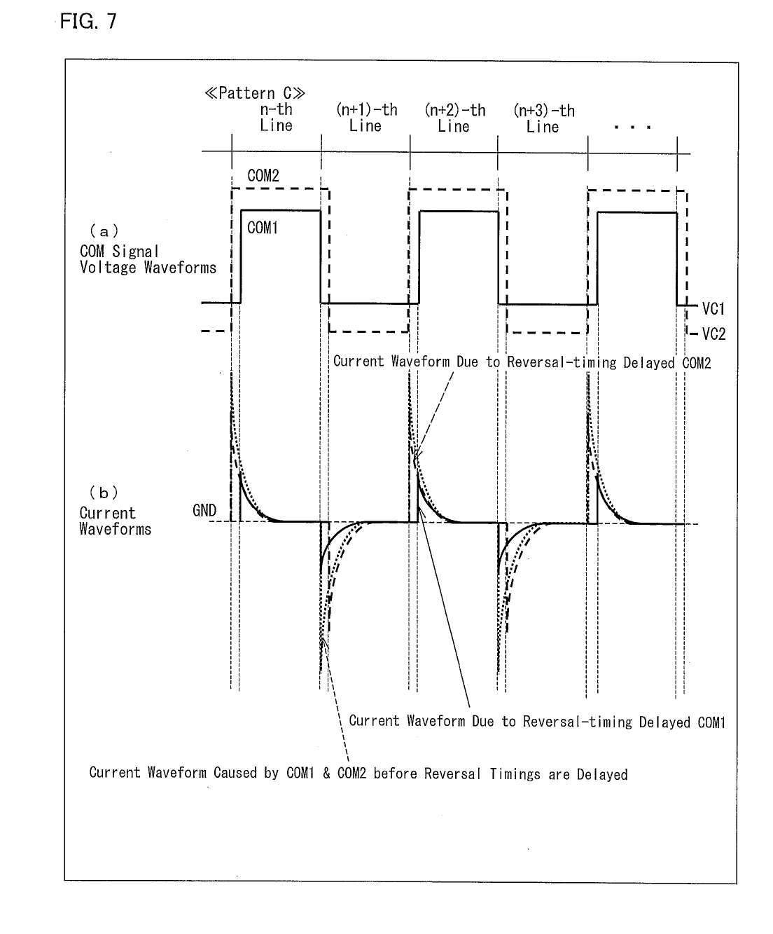

FIG. 7 shows (i) a timing chart of signals applied to the respective first and second common electrodes 11 and 12 in Pattern C ((a) of FIG. 7) and (ii) current waveform diagrams corresponding to the timing chart ((b) of FIG. 7).

In Pattern C, as shown in (a) of FIG. 7, (i) a first common electrode signal VC1 has an amplitude which is smaller than that of the second common electrode signal VC2, (ii) a rising edge of a polarity reversal of the first common electrode signal VC1 is delayed with respect to a rising edge of a polarity reversal of the second common electrode signal VC2, and (iii) a falling edge of a polarity reversal of the second common electrode signal VC2 is delayed with respect to a falling edge of a polarity reversal of the first common electrode signal VC1.

According to Pattern C, a timing of a polarity reversal of the first common electrode signal VC1 is delayed with respect to a timing of a polarity reversal of the second common electrode signal VC2 with regard to the time difference (1), and a timing of a polarity reversal of the second common electrode signal VC2 is delayed with respect to a timing of a polarity reversal of the first common electrode signal VC1 with regard to the time difference (2).

According to Pattern C, (i) a rising timing of the second common electrode signal VC2 is synchronized with a switching from a given horizontal scan period ((n−1)-th line) to a succeeding horizontal scan period (n-th line), with regard to rising edges of the first and second common electrode signals and (ii) a falling timing of the first common electrode signal VC1 is synchronized with a switching from the n-th line to a succeeding (n+1)-th line, with regard to falling edges of the first and second common electrode signals.

The current waveform diagram in (b) of FIG. 7 further shows the comparative current waveform shown in (b) of FIG. 5, as well as a current waveform corresponding to the timing chart of Pattern C. As is clear from (b) of FIG. 7 that an inrush current is dispersed along a time axis by delaying a timing of a polarity reversal of the first common electrode signal VC1 and a timing of a corresponding polarity reversal of the second common electrode signal VC2. In other words, Pattern C is a driving method capable of holding down peak values (transient values) of the current waveform as compared with a comparative circuit configuration.

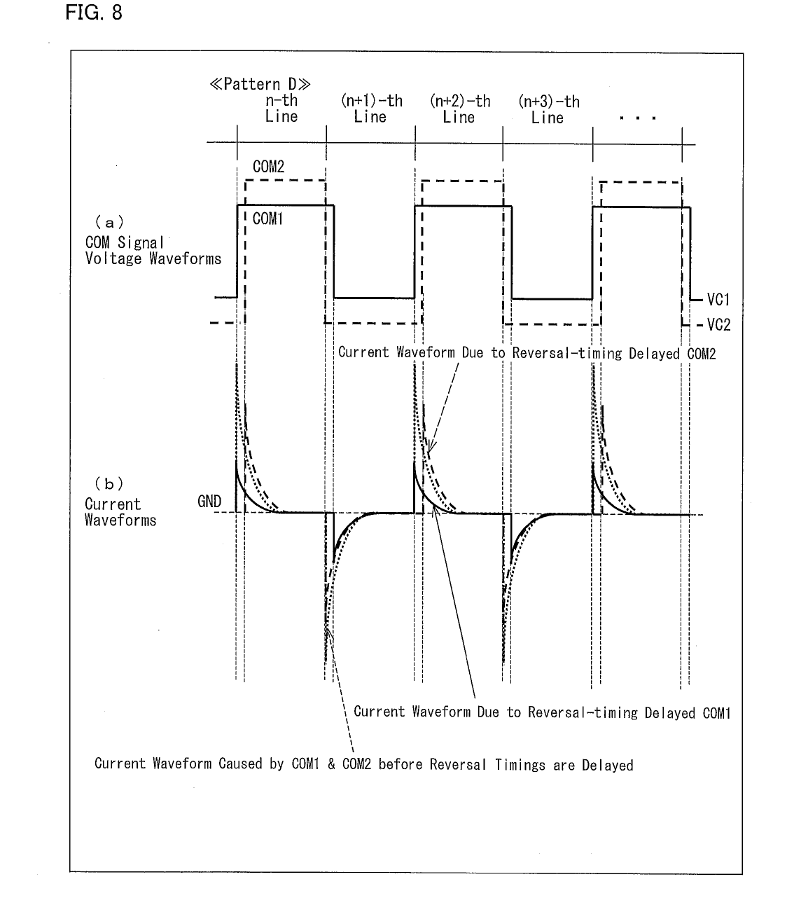

FIG. 8 shows (i) a timing chart of signals applied to the respective first and second common electrodes 11 and 12 in Pattern D ((a) of FIG. 8) and (ii) current waveform diagrams corresponding to the timing chart ((b) of FIG. 8).

In Pattern D, as shown in (a) of FIG. 8, (i) a first common electrode signal VC1 has an amplitude which is smaller than that of the second common electrode signal VC2, (ii) a rising timing of a polarity reversal of the second common electrode signal VC2 is delayed with respect to a rising timing of a polarity reversal of the first common electrode signal VC1, and (iii) a falling timing of a polarity reversal of the first common electrode signal VC1 is delayed with respect to a falling timing of a polarity reversal of the second common electrode signal VC2. According to Pattern D, a timing of a polarity reversal of the second common electrode signal VC2 is delayed with respect to a timing of a polarity reversal of the first common electrode signal VC1 with regard to the time difference (1), and a timing of a polarity reversal of the first common electrode signal VC1 is delayed with respect to a timing of a polarity reversal of the second common electrode signal VC2 with regard to the time difference (2).

According to Pattern D, (i) a rising timing of the first common electrode signal VC1 is synchronized with a switching from a given horizontal scan period ((n−1)-th line) to a succeeding horizontal scan period (n-th line), with regard to rising edges of the first and second common electrode signals and (ii) a falling timing of the second common electrode signal VC2 is synchronized with a switching from the n-th line to a succeeding (n+1)-th line, with regard to falling edges of the first and second common electrode signals.

The current waveform diagram in (b) of FIG. 8 further shows the comparative current waveform shown in (b) of FIG. 5, as well as a current waveform corresponding to the timing chart of Pattern D. As is clear from (b) of FIG. 8 that an inrush current is dispersed along a time axis by delaying a timing of a polarity reversal of the first common electrode signal VC1 and a timing of a corresponding polarity reversal of the second common electrode signal VC2. In other words, Pattern D is a driving method capable of holding down peak values (transient values) of the current waveform as compared with a comparative circuit configuration.

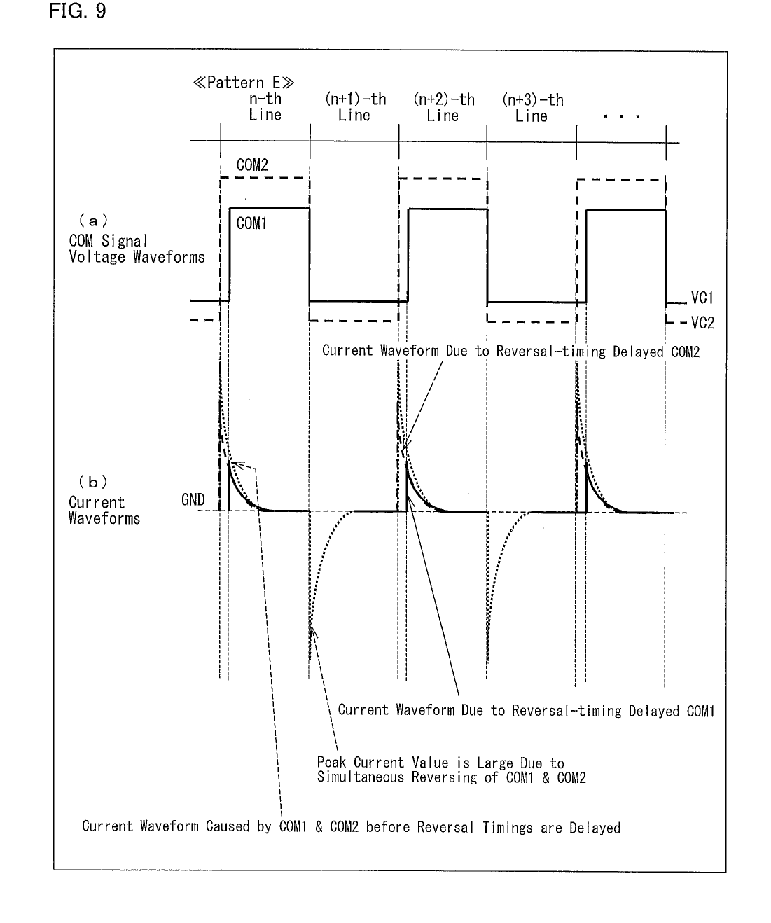

FIG. 9 shows (i) a timing chart of signals applied to the respective first and second common electrodes 11 and 12 in Pattern E ((a) of FIG. 9) and (ii) current waveform diagrams corresponding to the timing chart ((b) of FIG. 9).

In Pattern E, as shown in (a) of FIG. 9, (i) a first common electrode signal VC1 has an amplitude which is smaller than that of the second common electrode signal VC2, and (ii) a rising timing of a polarity reversal of the second common electrode signal VC2 is delayed with respect to a rising timing of a polarity reversal of the first common electrode signal VC1. In contrast, a falling timing of a polarity reversal of the first common electrode signal VC1 and a falling timing of a polarity reversal of the second common electrode signal VC2 are simultaneous. According to Pattern E, a timing of a polarity reversal of the first common electrode signal VC1 is delayed with respect to a timing of a polarity reversal of the second common electrode signal VC2 with regard to the time difference (1), and the first common electrode signal VC1 and the second common electrode signal VC2 are simultaneously subjected to respective polarity reversals with regard to the time difference (2).

According to Pattern E, (i) a rising timing of the second common electrode signal VC2 is synchronized with a switching from a given horizontal scan period ((n−1)-th line) to a succeeding horizontal scan period (n-th line), with regard to rising edges of the first and second common electrode signals and (ii) the falling timings of the polarity reversals of the first common electrode signal VC1 and the second common electrode signal VC2 are synchronized with a switching from the n-th line to a succeeding (n+1)-th line, with regard to falling edges of the first and second common electrode signals.

The current waveform diagram in (b) of FIG. 9 further shows the comparative current waveform shown in (b) of FIG. 5, as well as a current waveform corresponding to the timing chart of Pattern E. As is clear from (b) of FIG. 9 that an inrush current is dispersed along a time axis by delaying a timing of a polarity reversal of the first common electrode signal VC1 and a timing of a corresponding polarity reversal of the second common electrode signal VC2. In other words, Pattern E is a driving method capable of holding down peak values (transient values) of the current waveform as compared with a comparative circuit configuration.

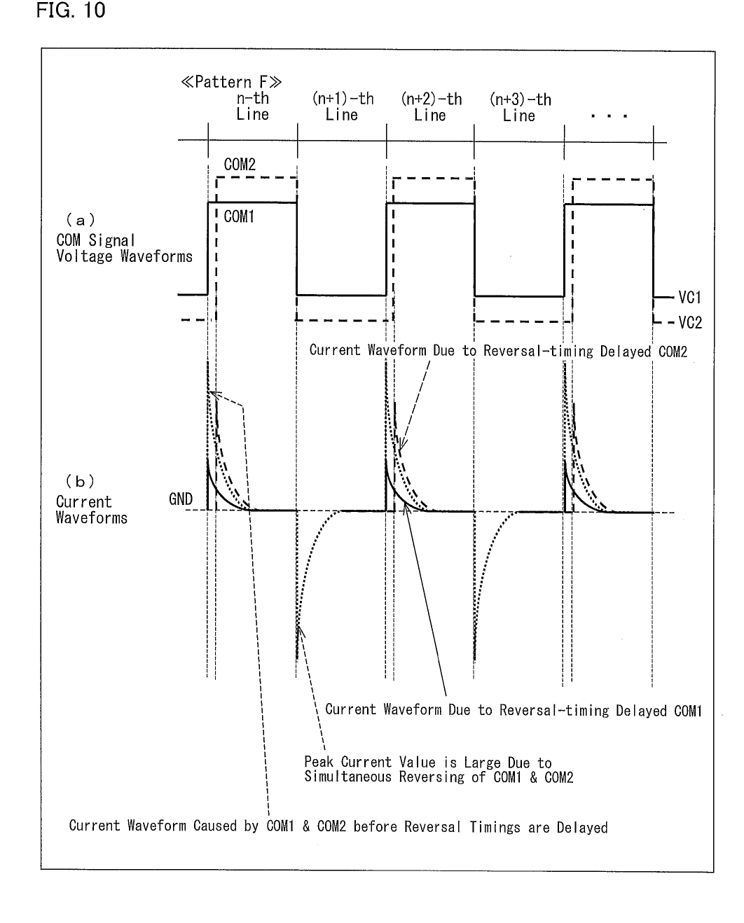

FIG. 10 shows (i) a timing chart of signals applied to the respective first and second common electrodes 11 and 12 in Pattern F ((a) of FIG. 10) and (ii) current waveform diagrams corresponding to the timing chart ((b) of FIG. 10).

In Pattern F, as shown in (a) of FIG. 10, (i) a first common electrode signal VC1 has an amplitude which is smaller than that of the second common electrode signal VC2, and (ii) a rising timing of a polarity reversal of the first common electrode signal VC1 is delayed with respect to a rising timing of a polarity reversal of the second common electrode signal VC2. In contrast, a falling timing of a polarity reversal of the first common electrode signal VC1 and a falling timing of a polarity reversal of the second common electrode signal VC2 are simultaneously. A “rising point in time of a common electrode signal” and a “falling point in time of a common electrode signal” are defined for Pattern F in the same way as for Pattern B. According to Pattern F, a timing of a polarity reversal of the second common electrode signal VC2 is delayed with respect to a timing of a polarity reversal of the first common electrode signal VC1 with regard to the time difference (1), and the first common electrode signal VC1 and the second common electrode signal VC2 are simultaneously subjected to respective polarity reversals with regard to the time difference (2).

According to Pattern F, (i) a rising timing of the first common electrode signal VC1 is synchronized with a switching from a given horizontal scan period ((n−1)-th line) to a succeeding horizontal scan period (n-th line), with regard to rising edges of the first and second common electrode signals and (ii) the falling timings of the polarity reversals of the first common electrode signal VC1 and the second common electrode signal VC2 are synchronized with a switching from the n-th line to a succeeding (n+1)-th line, with regard to falling edges of the first and second common electrode signals.

The current waveform diagram in (b) of FIG. 10 further shows the comparative current waveform shown in (b) of FIG. 5, as well as a current waveform corresponding to the timing chart of Pattern F. As is clear from (b) of FIG. 10 that an inrush current is dispersed along a time axis by delaying a timing of a polarity reversal of the first common electrode signal VC1 and a timing of a corresponding polarity reversal of the second common electrode signal VC2. In other words, Pattern F is a driving method capable of holding down peak values (transient values) of the current waveform as compared with a comparative circuit configuration.

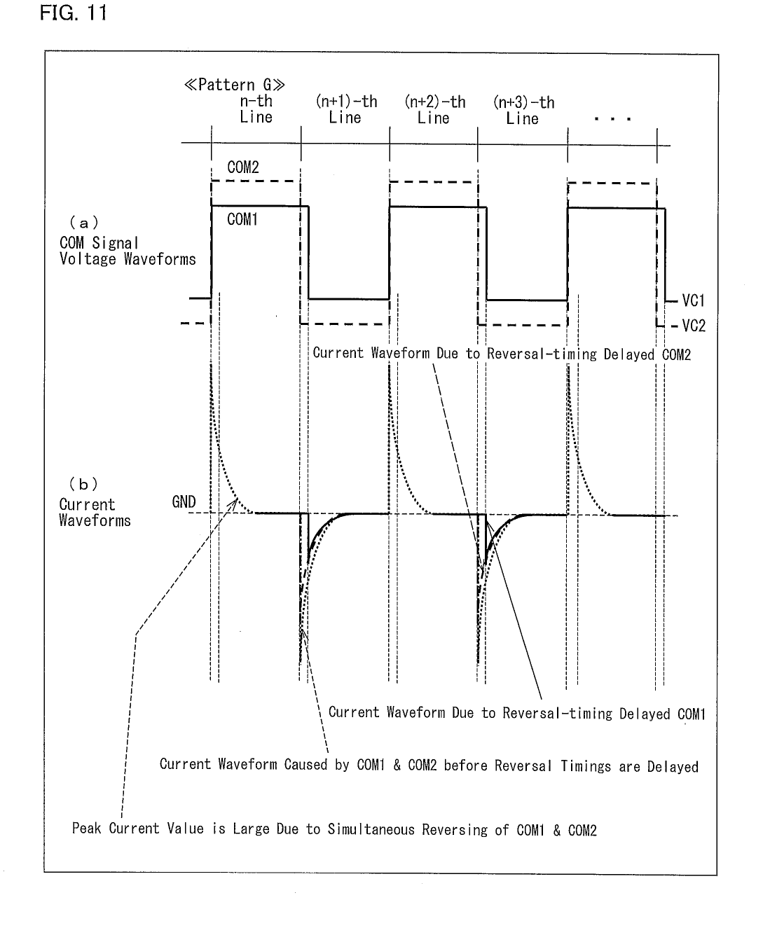

FIG. 11 shows (i) a timing chart of signals applied to the respective first and second common electrodes 11 and 12 in Pattern G ((a) of FIG. 11) and (ii) current waveform diagrams corresponding to the timing chart ((b) of FIG. 11).

In Pattern G, as shown in (a) of FIG. 11, (i) a first common electrode signal VC1 has an amplitude which is smaller than that of the second common electrode signal VC2, and (ii) a rising timing of a polarity reversal of the first common electrode signal VC1 and a rising timing of a polarity reversal of the second common electrode signal VC2 are simultaneously. In contrast, a falling timing of a polarity reversal of the first common electrode signal VC1 is delayed with respect to a falling timing of a polarity reversal of the second common electrode signal VC2. According to Pattern G, the first common electrode signal VC1 and the second common electrode signal VC2 are simultaneously subjected to respective polarity reversals with regard to the time difference (1), and a timing of a polarity reversal of the first common electrode signal VC1 is delayed with respect to a timing of a polarity reversal of the second common electrode signal VC2 with regard to the time difference (2).

According to Pattern G, (i) the rising timings of the polarity reversals of the first common electrode signal VC1 and the second common electrode signal VC2 are synchronized with a switching from a given horizontal scan period ((n−1)-th line) to a succeeding horizontal scan period (n-th line), with regard to rising edges of the first and second common electrode signals and (ii) a falling timing of the second common electrode signal VC2 is synchronized with a switching from the n-th line to a succeeding (n+1)-th line, with regard to falling edges of the first and second common electrode signals.

The current waveform diagram in (b) of FIG. 11 further shows the comparative current waveform shown in (b) of FIG. 5, as well as a current waveform corresponding to the timing chart of Pattern G. As is clear from (b) of FIG. 11 that an inrush current is dispersed along a time axis by delaying a timing of a polarity reversal of the first common electrode signal VC1 and a timing of a corresponding polarity reversal of the second common electrode signal VC2. In other words, Pattern G is a driving method capable of holding down peak values (transient values) of the current waveform as compared with a comparative circuit configuration.

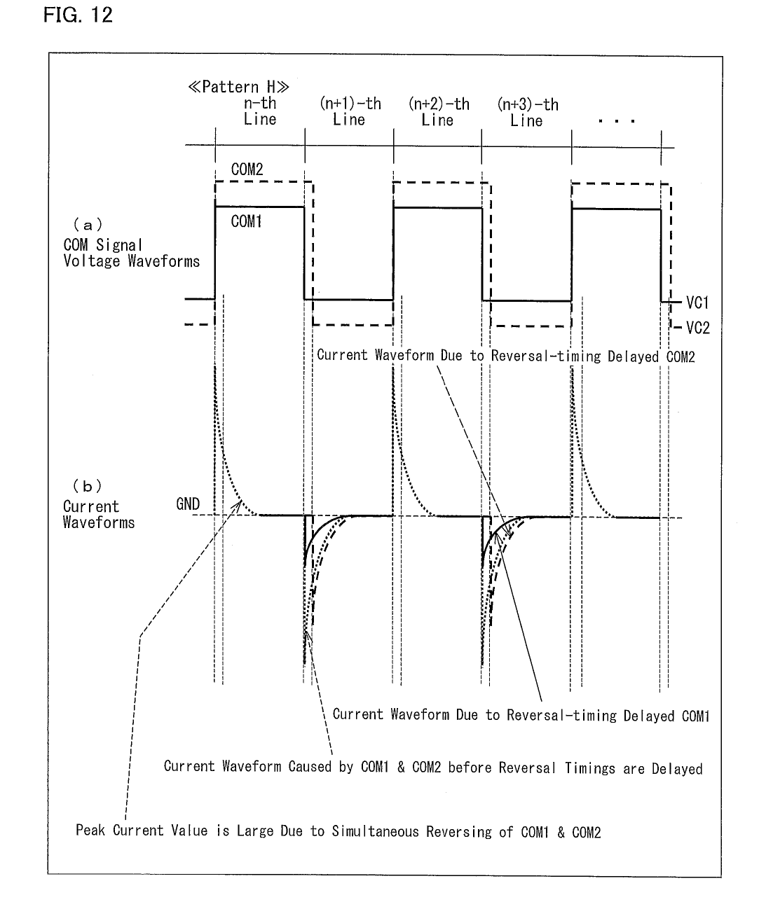

FIG. 12 shows (i) a timing chart of signals applied to the respective first and second common electrodes 11 and 12 in Pattern H ((a) of FIG. 12) and (ii) current waveform diagrams corresponding to the timing chart ((b) of FIG. 12).

In Pattern H, as shown in (a) of FIG. 12, (i) a first common electrode signal VC1 has an amplitude which is smaller than that of the second common electrode signal VC2, and (ii) a rising timing of a polarity reversal of the first common electrode signal VC1 and a rising timing of a polarity reversal of the second common electrode signal VC2 are simultaneously. In contrast, a falling timing of a polarity reversal of the second common electrode signal VC2 is delayed with respect to a falling timing of a polarity reversal of the first common electrode signal VC1. According to Pattern H, the first common electrode signal VC1 and the second common electrode signal VC2 are simultaneously subjected to respective polarity reversals with regard to the time difference (1), and a timing of a polarity reversal of the second common electrode signal VC2 is delayed with respect to a timing of a polarity reversal of the first common electrode signal VC1 with regard to the time difference (2).

According to Pattern H, (i) the rising timings of the polarity reversals of the first common electrode signal VC1 and the second common electrode signal VC2 are synchronized with a switching from a given horizontal scan period ((n−1)-th line) to a succeeding horizontal scan period (n-th line), with regard to rising edges of the first and second common electrode signals and (ii) a falling timing of the first common electrode signal VC1 is synchronized with a switching from the n-th line to a succeeding (n+1)-th line, with regard to falling edges of the first and second common electrode signals.

The current waveform diagram in (b) of FIG. 12 further shows the comparative current waveform shown in (b) of FIG. 5, as well as a current waveform corresponding to the timing chart of Pattern H. As is clear from (b) of FIG. 12 that an inrush current is dispersed along a time axis by delaying a timing of a polarity reversal of the first common electrode signal VC1 and a timing of a corresponding polarity reversal of the second common electrode signal VC2. In other words, Pattern H is a driving method capable of holding down peak values (transient values) of the current waveform as compared with a comparative circuit configuration.

### (Arrangement for Adjusting Timing of Polarity Reversal)

With reference to FIG. 1, the following description will discuss an arrangement for delaying a timing of a polarity reversal (i.e., for securing a time difference) indicated on Patterns A through H discussed above, in the liquid crystal display device of Embodiment 1.

A polarity reversing signal is supplied, from the timing controller CTRL in the control device shown in FIG. 1, to a polarity reversing signal delay circuit (control means) A and a polarity reversing signal delay circuit (control means) B in the control device. After being processed in the polarity reversing signal delay circuits A and B, the polarity reversing signal is then supplied to (i) to a first common electrode signal (COM1 signal) generating circuit for generating the first common electrode signal and (ii) to a second common electrode signal (COM2 signal) generating circuit for generating the second common electrode signal.

The polarity reversing signal delay circuit A can be enabled or disabled in accordance with a control signal A shown in FIG. 1. The polarity reversing signal delay circuit B can be enabled or disabled in accordance with a control signal B shown in FIG. 1. According to the arrangement, in a case where only the first common electrode signal VC1 is delayed as illustrated, for example, in FIG. 6, only the polarity reversing signal delay circuit A is enabled in accordance with the control signal A. In a case where only the second common electrode signal VC2 is delayed as illustrated in FIG. 5, only the polarity reversing signal delay circuit B is enabled in accordance with the control signal B. According to the arrangement shown in FIG. 1, common electrode signals can be selectively delayed at its rising and/or falling edges.

The time difference is preferably not longer than a time period obtained by subtracting, from one (1) horizontal scan period, a time period during which a voltage is applied to a gate electrode provided in the TFT 30 (see FIG. 1). This is because of the following reason. Namely, if (i) a writing (charging) period for the pixel and (ii) a time point at which a common electrode voltage is subjected to a polarity reversal over lap each other, then there is a possibility that the pixel is insufficiently charged. In view of the circumstances, the time difference is set as described above. This causes (i) the writing (charging) period for the pixel and (ii) the time point at which a common electrode voltage is subjected to a polarity reversal not to over lap each other. It is therefore possible for the pixel to be sufficiently charged.

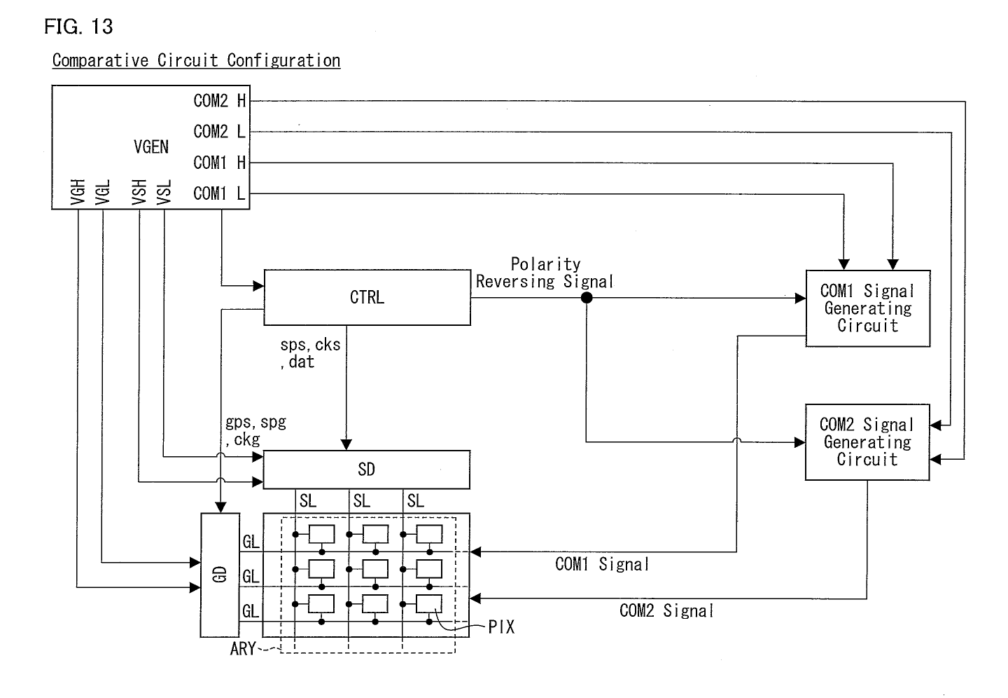

The following description will briefly discuss circuit blocks of the comparative circuit configuration. FIG. 13 is a block diagram showing a comparative circuit configuration. According to the comparative circuit configuration, neither the polarity reversing signal delay circuit A nor the polarity reversing signal delay circuit B is provided, unlike Embodiment 1 shown in FIG. 1. As such, a polarity reversing signal is supplied, from a timing controller CTRL, to a COM1 signal (first common electrode signal) generating circuit and a COM2 signal (second common electrode signal) generating circuit. The first and second common electrode signals have respective polarities which vary in accordance with the polarity reversing signal, and are then supplied to respective common electrodes. With the comparative circuit configuration, the first and second common electrode signals are subjected to respective polarity reversals (High or Low) in synchronism with a High level or a Low level of the polarity reversing signal (phases can differ by 180°).

Note that FIG. 1 shows a circuit configuration in which the first common electrode signal VC1 and the second common electrode signal VC2 can be both delayed. The arrangement of FIG. 1 can thus realize all of the foregoing patterns. Note, however, that in a case where only one of the common electrode signals is delayed, it should be appreciated that it is not necessary for the other of the common electrode signals to be provided. In this case, it is possible to provide only blocks that are dedicated to some of the patterns.

### (Alternative Example Configuration (1) for Adjusting Timing of Polarity Reversal)

The following description will discuss alternative Example Configuration (1) for adjusting a timing of a polarity reversal

As early described, according to Embodiment 1, in a case where a time difference is secured between the timings of the polarity reversals of the first common electrode signal VC1 and the second common electrode signal VC2, such a time difference is secured when the common electrode signals start their respective polarity reversals. The time difference (delay time) between time points at which the common electrode signals start their respective polarity reversals can be an integral multiple of half a cycle of a reference clock which is used in the liquid crystal display device 1 (see FIG. 1).

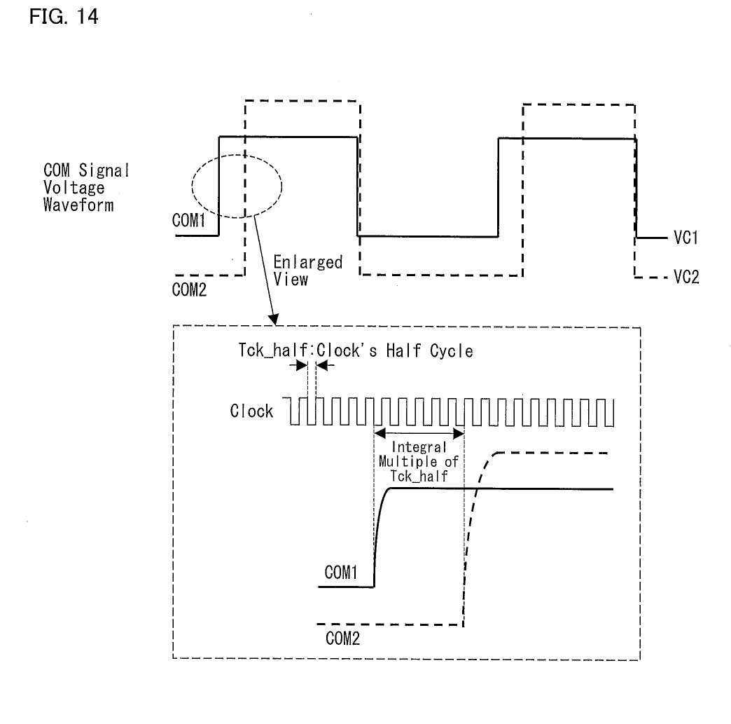

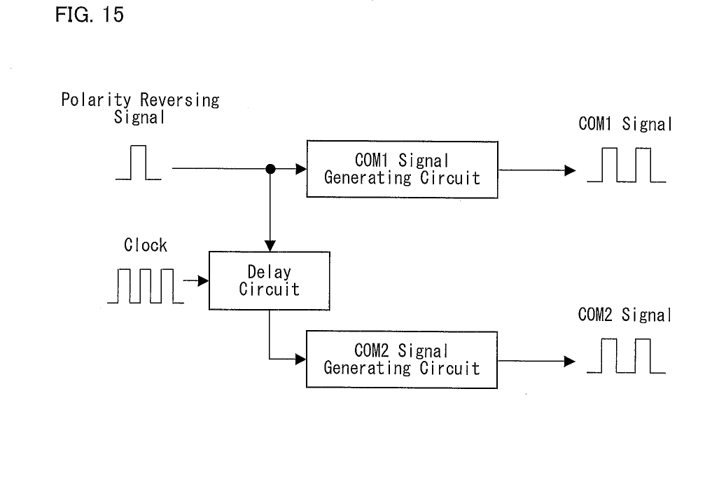

FIG. 14 shows an example case, with regard to rising edges of the common electrode signals, in which the second common electrode signal VC2 is subjected to a polarity reversal (rising) with a delay with respect to the first common electrode signal VC1. As is clear from FIG. 14, it is possible to realize, with the use of a simple circuit configuration, an adjustment of the timings of rising edges and/or falling edges of polarity reversals, by setting, to an integral multiple of half a cycle of the reference clock signal, a time difference between the starts of the polarity reversals of the respective first and second common electrode signals. FIG. 15 shows, using a part of FIG. 1, a circuit configuration with which FIG. 14 is embodied.

Examples of the reference clock signal encompass a video interface clock signal which is supplied to the liquid crystal display device 1 (see FIG. 1). This allows the present invention to be implemented with the use of a simple circuit configuration.

Alternatively, internal oscillator clock signals (cks and ckg in FIG. 1) generated by the liquid crystal display device 1 (see FIG. 1) can be employed as the reference clock. This also allows the present invention to be implemented with the use of a simple circuit configuration.

### (Alternative Example Configuration 2) for Adjusting Timing of Polarity Reversal)

The following description will discuss alternative Example Configuration (2) for adjusting a timing of a polarity reversal.

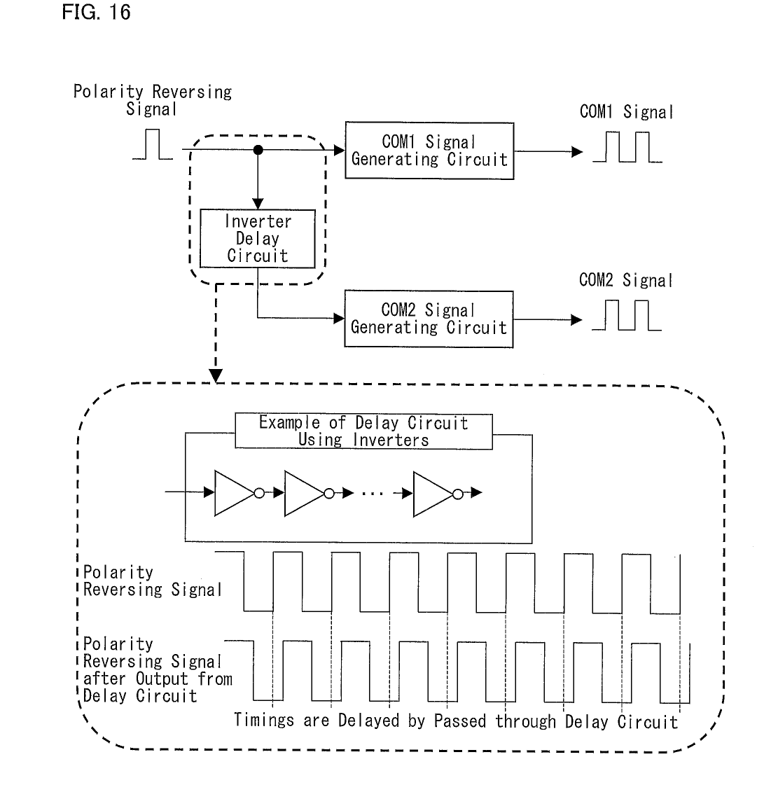

According to Example Configuration (2), in a case where the second common electrode signal VC2 is subjected to a polarity reversal (rising) with a delay with respect to the first common electrode signal VC1, the second common electrode signal VC2 is delayed by supplying a polarity reversing signal to an inverter delay circuit so that the second common electrode signal VC2 is passed through the inverter delay circuit as illustrated in FIG. 16.

Note, however, that Example Configuration (2) is not limited to the inverter delay circuit. Alternatively, a buffer circuit can be provided so as be followed by a common electrode signal generating circuit which generates a delayed common electrode signal. With the circuit configuration, a polarity reversing signal is supplied to the common electrode signal generating circuit, via the buffer circuit in which the polarity reversing signal is passed through a plurality of buffers which are cascade-connected so as to cause a delay.

Alternatively, Example Configuration (2) and Example Configuration (1) can be combined.

### (Function and Effect of Liquid Crystal Display Device of Embodiment 1)

As early described, the liquid crystal display device 1 of Embodiment 1, as is clear from FIG. 1, includes control means (timing controller CTRL and polarity reversing signal delay circuits A and B in FIG. 1) for implementing such control to provide, in a given horizontal scan period, a time difference between a timing of a polarity reversal of the first common electrode voltage and a timing of a corresponding polarity reversal of the second common electrode voltage either when the first and second common electrode voltages rise or when they fall, or both when they rise and fall, for the polarity reversals. This prevents the first and second common electrode voltages from being simultaneously subjected to respective polarity reversals, securing the time difference (delay) between the timings, examples of which are shown in Patterns A through H. This time difference disperses the peaks (instantaneous values) of a current waveform along the time axis and prevents the peaks from being concentrated at any point in time. Thus, in a liquid crystal display device, having wide viewing angle characteristics, in which a plurality of subpixels are formed by providing a plurality of common electrodes to face pixel electrodes, it is possible to suppress increases in the electric current needed in polarity reversal of the common electrode voltages.

In addition, this arrangement allows generation of inconvenient inrush current to be held down and therefore eliminates the conventional, undesirable need to use costly components in designing a system-end power supply.

A timing of a polarity reversal is delayed for each horizontal scan period according to Embodiment 1. The present invention is, however, not limited to this. Alternatively, a timing can be delayed every two horizontal scan periods. Alternatively, a timing can be adjusted as discussed above every integral multiple of the horizontal scan period.

Note that a timing of a polarity reversal can be delayed based on the horizontal scan period. The present invention is effective for timing adjustment for a polarity reversal of a blanking period for a vertical scan period, instead of a horizontal scan period.

Embodiment 1 has discussed, as an example, the liquid crystal display device which operates in VA mode. Embodiment 1 is, however, not limited to this. Alternatively, Embodiment 1 encompasses a liquid crystal display device which operates in TN mode, a liquid crystal display device, in which pixel electrodes and common electrodes are provided in a single plane and which operates in IPS mode, and other types of liquid crystal display devices.

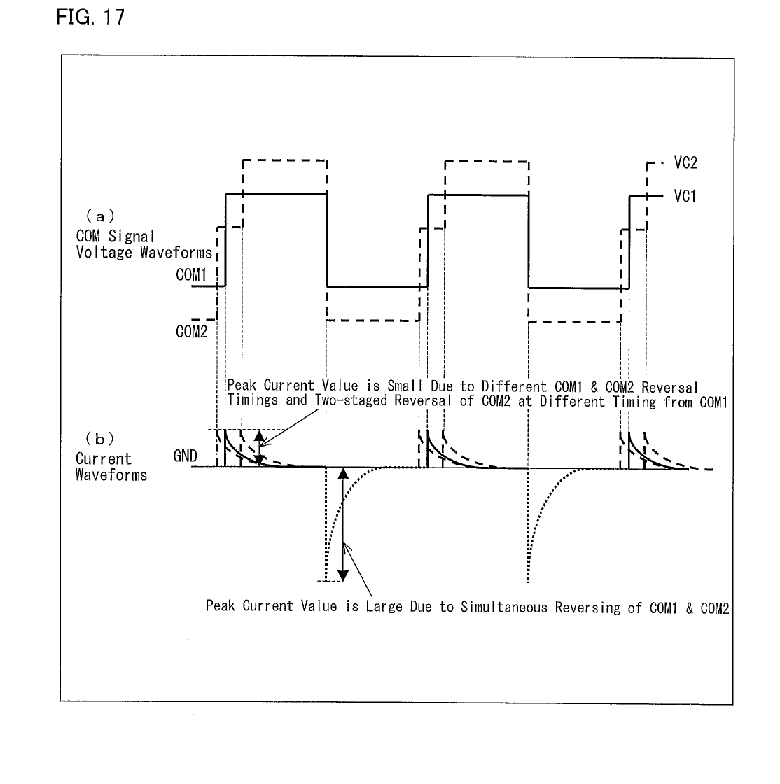

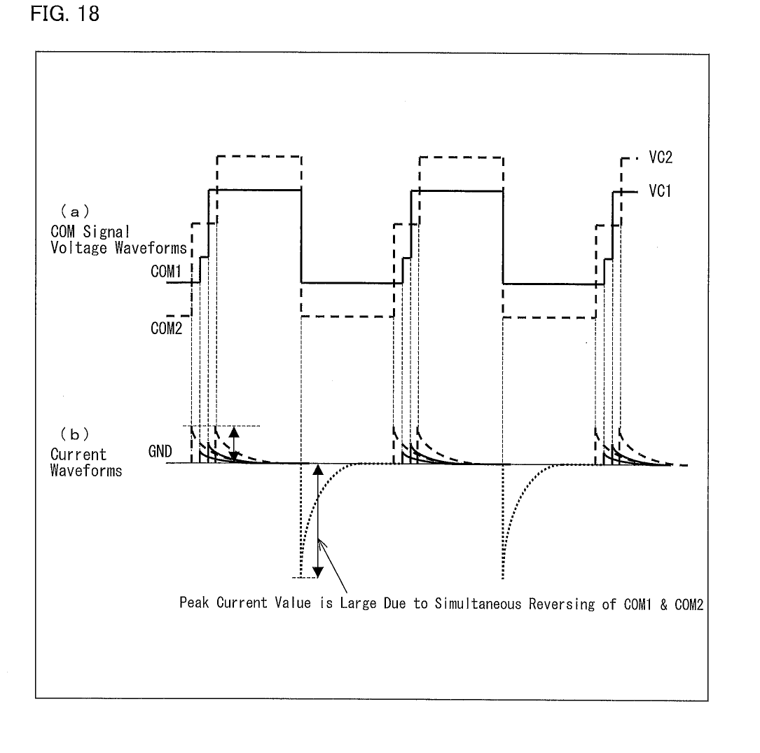

The following description will discuss Embodiment 2 of a liquid crystal display device in accordance with the present invention in reference to FIGS. 17 and 18. For convenience, the members of Embodiment 2 that have the same functions as the members of Embodiment 1 are indicated by the respective same reference numerals and their respective detailed descriptions are omitted.

According to Embodiment 1, with regard to a transition of a polarity reversal of the first or second common electrode signal whichever is later, the first or second common electrode signal continuously changes from a predetermined low voltage (a predetermined low electric potential) to a predetermined high voltage (a predetermined high electric potential), for example, at a rising edge of the polarity reversal. In contrast, according to Embodiment 2, at a transition of a polarity reversal of at least one of the first and second common electrode signals, the transition from a predetermined low (high) voltage to a predetermined high (low) voltage is carried out in a plurality of transition periods, and a delay occurs between (i) a timing of a polarity reversal of the first common electrode signal and (ii) a timing of a polarity reversal of the second common electrode signal.

“The transition is carried out in a plurality of transition periods at the polarity reversal” means that periods are secured at an intermediate voltage between a predetermined low (high) voltage and a predetermined high (low) voltage, in each of which periods a voltage (electric potential) does not change as much as it does in a predetermined period.

The transition can be carried out in a plurality of transition periods only at rising edges ((1) described in Embodiment 1), only at falling edges ((2) described in Embodiment 1), or both at rising edges and falling edges (both (1) and (2) described in Embodiment 1).

A method, in which a polarity reversal is carried out in a plurality of transition periods, can be realized by employing the foregoing conventionally known method.

The following description will discuss Embodiment 2 by exemplifying two patterns, i.e., Pattern I and Pattern J.

FIG. 17 shows (i) a timing chart of signals applied to the respective first and second common electrodes 11 and 12 in Pattern I ((a) of FIG. 17) and (ii) current waveform diagrams corresponding to the timing chart ((b) of FIG. 17).

In Pattern I, as shown in (a) of FIG. 17, at a rising edge for a polarity reversal, a second common electrode signal VC2 changes from a predetermined low voltage (predetermined low electric potential) to a predetermined high voltage (electric potential) through two-step transition periods, i.e., former and latter transition periods. A timing of a polarity reversal of the latter transition period is delayed with respect to a polarity reversal of the first common electrode signal VC1, but the polarity reversal of the first common electrode signal VC1 is delayed with respect to a timing of a polarity reversal of the former transition period.

Specifically, at rising edges of the common electrode signal shown in (a) of FIG. 17, the polarity reversal of the second common electrode signal VC2 starts earlier than the first common electrode signal VC1 starts, whereas the first common electrode signal VC1 reaches the predetermined high voltage (i.e., its polarity reversal is completed) before the second common electrode signal VC2 reaches the predetermined high voltage (i.e., when its polarity reversal is completed).

Note that Pattern I is applicable not only to a rising edge, but also to a falling edge, as early described.

Pattern I has an advantage, as shown in (b) of FIG. 17, of being capable of further holding down peak values of inrush currents at respective rising edges. Specifically, in Pattern A exemplified in Embodiment 1, the peak current values are held down by completely delaying the timings of the polarity reversals of the first common electrode signal VC1 and the second common electrode signal VC2, as compared with the comparative circuit configuration in FIG. 13 in which the polarity reversals occur simultaneously. Due to an difference in amplitude between the first common electrode signal VC1 and the second common electrode signal VC2, however, the peak values of the inrush currents caused by the second common electrode signal VC2 are greater than that caused by the first common electrode signal VC1. In order to address this, the peak values of the inrush currents can be further held down by employing Pattern I. According to Pattern I, (i) the timing of the polarity reversal of the second common electrode signal VC2, which has a greater amplitude than that of the first common electrode signal VC1, is made to completely differ from the timing of the polarity reversal of the first common electrode signal VC1, and (ii) the second common electrode signal VC2 is controlled so that the transition is carried out in the plurality of transition periods.

FIG. 18 shows (i) a timing chart of signals applied to the respective first and second common electrodes 11 and 12 in Pattern L ((a) of FIG. 18) and (ii) current waveform diagrams corresponding to the timing chart ((b) of FIG. 18).

Pattern L differs from Pattern I in that the first common electrode signal VC1, similarly to the second common electrode signal VC2, each transition of its voltage is carried out in a plurality of transition periods at a corresponding rising edge, as shown in (a) of FIG. 18.

Pattern L has an advantage, as shown in (b) of FIG. 18, of being capable of making peak values of inrush currents wholly smaller because both the first common electrode signal VC1 and the second common electrode signal VC2 have smaller changes in electric current at their respective rising edges. This is lower than peak values of the current waveform for the comparative circuit configuration in FIG. 13 (not shown in (b) of FIG. 18).

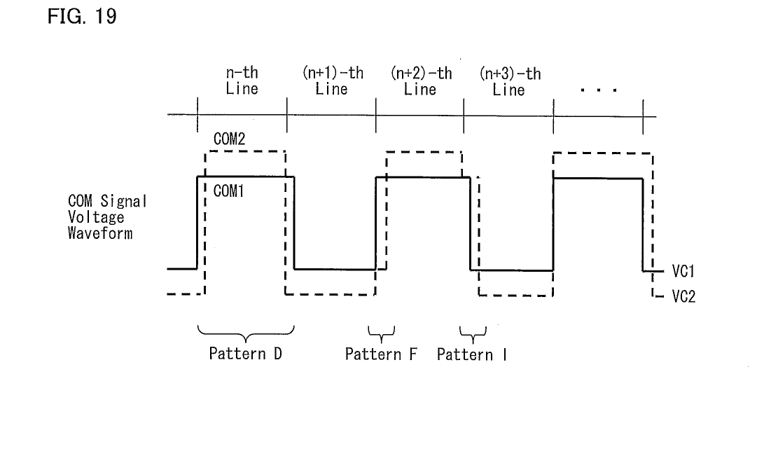

The following description will discuss Embodiment 3 of a liquid crystal display device in accordance with the present invention in reference to FIG. 19. For convenience, the members of Embodiment 3 that have the same functions as the members of either Embodiment 1 or 2 are indicated by the respective same reference numerals and their respective detailed descriptions are omitted.

A feature of Embodiment 3 resides in that timings of polarity reversals of one of common electrode signals are periodically or non-periodically (randomly) made to differ from, or to coincide with, those of another common electrode signal in successive horizontal scan periods. Another feature of Embodiment 3 resides in that, according to each of Pattern A through Pattern H of Embodiment 1 and Pattern I and Pattern J of Embodiment 2, the timings of the polarity reversals of the first common electrode signal VC1 are delayed with respect to those of the second common electrode signal VC2 in each line in accordance with one and the same Pattern. In contrast, according to Embodiment 3, in a case where timings of the polarity reversals of the first common electrode signal VC1 are delayed with respect to those of the second common electrode signal VC2, one of Pattern A through Pattern J is selected (i) for each horizontal scan period or (ii) every two or more horizontal scan periods.

FIG. 19 shows an example of Embodiment 3. (a) of FIG. 19 is a timing chart of signals applied to a first common electrode 11 and a second common electrode 12 over successive horizontal scan periods. (b) of FIG. 19 is a current waveform diagram corresponding to the timing chart.

FIG. 19 shows that timings of polarity reversals are delayed in a certain horizontal scan period (n-th line) and in subsequent horizontal scan periods. Note, however, that the timings of polarity reversals are not necessarily delayed for each line. Specifically, timings of polarity reversals are delayed, in the respective n-th through (n+2)-th lines, in accordance with one and the same Pattern, and a timing of polarity reversal is delayed, in the (n+3)-th line, in accordance with a different Pattern. The timings of polarity reversals can be thus delayed, in a plurality of successive lines, in accordance with one and the same Pattern.

In a case where the timings of polarity reversals are delayed in this manner, timings at which changes occur in electric current due to respective polarity reversals do not periodically occur, by changing a pattern to be selected for each line. This causes unnecessary radiation discharged by the liquid crystal display device 1 (see FIG. 1) to be dispersed over frequencies. As such, it is possible to reduce peak values of the unnecessary radiation energy.

Note that the first common electrode signal VC1 and the second common electrode signal VC2 can be simultaneously subjected to respective polarity reversals in some line (see a rising edge of the (n+3)-th line in FIG. 19).

Also note that Embodiment 3 has so far described an example configuration in which a pattern is selected for each line (or every two or more successive line). Embodiment 3 is, however, not limited to this. Alternatively, a pattern of timings of polarity reversals can be selected for each frame (or every two or more successive frames). This will be described below.

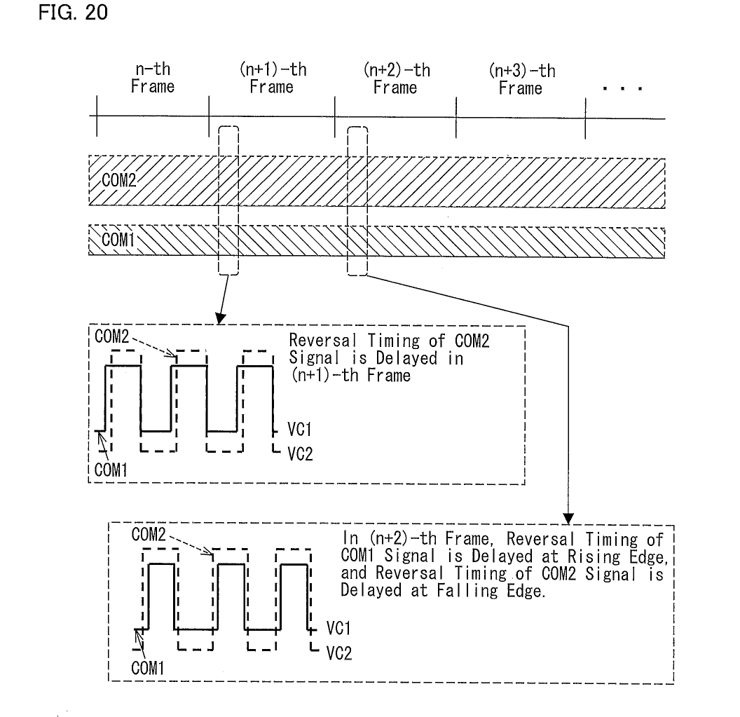

FIG. 20 shows alternative Example Configuration 3. In this example, a pattern is selected from those which are identical to Pattern A through Pattern G of Embodiment 1 for each frame. FIG. 20 shows that timings of polarity reversals of the common electrode signals in an (m+1)-th frame are different from those in an (m+2)-th frame. This another example is, however, not necessarily limited to this (the frames are not necessarily successive ones). Specifically, an identical polarity reversal pattern can be followed over a number of successive frames; for example, the timings of polarity reversals can be delayed according to a given identical pattern in the m, (m+1)-th, and (m+2)-th frames and according to a pattern which is different from the identical pattern in the (m+3)-th frame.

FIG. 20 shows two patterns. This another example is, however, not limited to such two patterns. Alternatively, three or more different timing patterns can be combined. In addition, the first common electrode signal VC1 and the second common electrode signal VC2 can simultaneously be subjected to respective polarity reversals in a certain frame.

In a case where the timings of polarity reversals are delayed in this manner, timings at which changes occur in electric current due to respective polarity reversals do not periodically occur, by changing a pattern to be selected for each frame. This causes unnecessary radiation discharged by the liquid crystal display device 1 (see FIG. 1) to be dispersed over frequencies. As such, it is possible to reduce peak values of the unnecessary radiation energy.

The present invention is not limited to the embodiments above, but can be altered in many ways by a skilled person in the art within the scope of the claims. An embodiment derived from a proper combination of technical means disclosed in different embodiments is also encompassed in the technical scope of the present invention. The embodiments and concrete examples of implementation discussed in the detailed description clarify the technical content of the present invention, which should not be narrowly interpreted within the limits of such embodiments and concrete examples, but rather can be applied in many variations within the spirit of the present invention, provided that such variations are not beyond the scope of the patent claims set forth below.

### (Recapitulation of Present Invention)

In view of the problems described above, it is an object of the present invention to provide a liquid crystal display device which exhibits a smaller transient inrush current value when the COM signal (COM voltage) is subjected to a polarity reversal.

In other words, a liquid crystal display device in accordance with the present invention, to address the problems, includes: an active matrix substrate on which a plurality of data signal lines and a plurality of scan signal lines which intersect with the plurality of data signal lines are provided, and a plurality of active elements and a plurality of pixel electrodes are provided at respective intersections of the plurality of data signal lines and the plurality of scan signal lines; a counter substrate provided opposite the active matrix substrate; a plurality of common electrodes provided on the active matrix substrate or the counter substrate, each of the plurality of common electrodes being made up of a first common electrode and a second common electrode, each of the plurality of pixel electrodes having (a) a region facing the first common electrode and (b) a region facing the second common electrode, the second common electrode being different from the first common electrode; a liquid crystal layer provided between the active matrix substrate and the counter substrate; first common electrode voltage application means for applying a first common electrode voltage to the first common electrode; second common electrode voltage application means for applying a second common electrode voltage to the second common electrode, the second common electrode voltage being different from the first common electrode voltage; and control means for controlling (i) the first common electrode voltage application means to apply the first common electrode voltage to the first common electrode so that the first common electrode voltage is subjected to a polarity reversal for each certain time period and (ii) the second common electrode voltage application means to apply the second common electrode voltage to the second common electrode so that the second common electrode voltage is subjected to a polarity reversal for each certain time period, said control means carrying out control so that a time difference is secured, in a given time period, at least one of: (1) between (a) a rising edge of a polarity reversal of a first common electrode voltage and (b) a rising edge of a polarity reversal of a second common electrode voltage, and (2) between (c) a falling edge of a polarity reversal of the first common electrode voltage and (d) a falling edge of a polarity reversal of the second common electrode voltage, where the rising edge of the polarity reversal indicates a time point at which the first or second common electrode voltage starts to rise from a first voltage to a second voltage which is larger than the first voltage, and the falling edge of the polarity reversal indicates a time point at which the first or second common electrode voltage starts to fall from a third voltage to a fourth voltage which is smaller than the third voltage.

According to the arrangement, a liquid crystal display device in accordance with the present invention can provide a liquid crystal display device which exhibits a smaller transient inrush current value when the COM signal (COM voltage) is subjected to a polarity reversal. The following description will discuss a case where the plurality of common electrodes are provided on the counter substrate, as an example.

First, the liquid crystal display device in accordance with the present invention is arranged so that each pixel electrode includes a region facing a first one of the plurality of common electrodes across a liquid crystal layer and a region facing a second one of the plurality of common electrodes across the liquid crystal layer, the second common electrode being different from the first common electrode and also that different common electrode voltages are applied to the first and second common electrodes. Accordingly, each pixel electrode includes at least a first region facing the first common electrode across the liquid crystal layer and a second region facing the second common electrode across the liquid crystal layer. When the liquid crystal display device is driven, the first common electrode voltage is applied to the first common electrode, and the second common electrode voltage is applied to the second common electrode. Since the first and second common electrode voltages have different voltage values as early described, the voltage applied across the liquid crystal layer in the first region, that is, the liquid crystal layer interposed between the first region of the pixel electrode and the first common electrode can be made to differ from the voltage applied across the liquid crystal layer in the second region, that is, the liquid crystal layer interposed between the second region of the pixel electrode and the second common electrode, or vice versa.

Furthermore, the liquid crystal display device has V-T characteristics that are in accordance with variable transmittances of the pixel regions averaged over the entire pixel. Display quality is hence improved for intermediate grayscale levels when the display screen of the liquid crystal display device is viewed from an oblique angle. In other words, the liquid crystal display device has improved viewing angle characteristics.

Viewing angle is increased in a case where the amplitude of either the first common electrode voltage (COM1) applied to the first common electrode or the second common electrode voltage (COM2) applied to the second common electrode is increased in excess of the amplitude of the conventional common electrode voltage (COM). This arrangement however also leads to a problem of increased inrush current occurring in reversing the COM signal. For example, the COM amplitude is 5 Vpp in a conventional arrangement (1), whereas in an arrangement (2) which includes COM1 and COM2, the COM1 amplitude is 4 Vpp, and the COM2 amplitude is 8.5 Vpp. The electric current needed to reverse the COM signal is given by the following equation:

Electric Current=f×C×Vpp,

where f is a reversal frequency, C is a liquid crystal capacitance, and Vpp is a COM amplitude. Hence,

Electric Current Needed for Arrangement(1)=f×C×5=5fC

Electric Current Needed for Arrangement(2)=f×(C/2)×4+f×(C/2)×8.5=6.25fC

These results show that the electric current needed in reversing the COM signal is greater in the arrangement (2). In addition, to prepare for the generation of this inconvenient inrush current, the system end needs to have a current supplying capability that is sufficient in view of the value of the inrush current to prevent a flow of inrush current from shutting down the power supply. In other words, costly components have to be used in designing a system-end power supply to prepare for the inrush current. According to the present invention, however, there is provided control means for controlling to provide, upon at least either rising or falling edges of polarity reversals of the first and second common electrode voltages in a given horizontal scan period, a time difference between the timing at which the first common electrode voltage is subjected to a polarity reversal and the timing at which the second common electrode voltage is subjected to a polarity reversal. Accordingly, not all the first and second common electrode voltages are subjected to a polarity reversal at once; the voltages are reversed at different timings. This time difference disperses the peaks (instantaneous values) of a current waveform along the time axis and prevents the peaks from being concentrated at any point in time.

Thus, in a liquid crystal display device, having wide viewing angle characteristics, in which a plurality of subpixels are formed by providing a plurality of common electrodes to face pixel electrodes, it is possible to suppress increases in the electric current needed in polarity reversal of the common electrode voltages.

In addition, this arrangement of the present invention allows generation of inconvenient inrush current to be held down in this manner, and therefore eliminates the need to use costly components in designing a system-end power supply.

In other words, it is possible to provide, at low cost, a liquid crystal display device, having wide viewing angle characteristics, which achieves low power consumption by restraining generation of inconvenient inrush current.

Therefore, according to the arrangement of the present invention, it is possible to realize wide viewing angle characteristics and also to lower the transient inrush current value (peak value) which is a problem that occurs in a conventional arrangement when the common electrode voltage is subjected to a polarity reversal.

Note that a polarity is a term that describes, in a relative manner, the relationship between the electric potential of a common electrode and the electric potential of a source in a period in which a voltage is applied to a pixel electrode. The state in which the source potential level is relatively high as compared with the electric potential of the common electrode is described as being positive, whereas the state in which the source potential level is relatively low as compared with the electric potential of the common electrode is described as being negative.

In addition, in the liquid crystal display device in accordance with the present invention, the control means can be arranged, in a manner opposite to the case above, to the time difference is secured by the control of said control means so that the polarity reversal of the first common electrode voltage is delayed with respect to the polarity reversal of the second common electrode voltage in a case where the first common electrode voltage has an amplitude which is smaller than that of the second common electrode voltage.

According the arrangement, in the liquid crystal display device in accordance with the present invention can delay the timing of the polarity reversal of the first common electrode voltage to disperse the peaks (instantaneous values) of a current waveform along the time axis.

Supposing that the common electrodes are driven with equal ability, the common electrode voltage with a smaller amplitude completes its polarity reversal (voltage change) more quickly. Therefore, delaying the timing at which the common electrode voltage with a smaller amplitude starts to rise enables both the common electrode voltages to complete rising at roughly the same time. In other words, the times in which a predetermined voltage is applied from the common electrodes to the first and second regions can be made equal to each other.

Furthermore, the liquid crystal display device in accordance with the present invention is preferably arranged, in addition to the above arrangement, so that the first common electrode voltage has an amplitude which is smaller than that of the second common electrode voltage; and the time difference is secured by the control of said control means so that the polarity reversal of the second common electrode voltage is delayed with respect to the polarity reversal of the first common electrode voltage.

According to the arrangement, the liquid crystal display device in accordance with the present invention can delay the timing of the polarity reversal of the second common electrode voltage to disperse the peaks (instantaneous values) of a current waveform along the time axis.

Furthermore, the liquid crystal display device in accordance with the present invention is preferably arranged, in addition to the above arrangement, so that the control means carries out the control so that the time difference is secured with respect to both of the (1) and (2); and the time differences are secured by the control of said control means so that (i) the polarity reversal of the first common electrode voltage is delayed with respect to the polarity reversal of the second common electrode voltage at the rising edge of the polarity reversal and (ii) the polarity reversal of the second common electrode voltage is delayed with respect to the polarity reversal of the first common electrode voltage at the falling edge of the polarity reversal.

The arrangement enables the peaks (instantaneous values) of a current waveform to be dispersed along the time axis as early described.

Especially, since the reversal cycles of individual COM1 and COM2 at the rising edge differ from those at the falling edge, the peak values of electric current in terms of frequency band can be lowered. Therefore, EMI can be more effectively restrained than the aforementioned aspect in which the reversal cycles of individual COM1 and COM2 at the rising edge are equal to those at the falling edge.

However, unlike the above arrangement, the control means can be arranged to carry out the control so that the time difference is secured with respect to both of the (1) and (2); and the time differences are secured by the control of said control means so that (i) the polarity reversal of the second common electrode voltage is delayed with respect to the polarity reversal of the first common electrode voltage at the rising edge of the polarity reversal and (ii) the polarity reversal of the first common electrode voltage is delayed with respect to the polarity reversal of the second common electrode voltage at the falling edge of the polarity reversal.

In addition, in place of the above arrangement, the control means carries out the control so that the time difference is secured merely with respect to the (1); the time difference is secured by the control of said control means so that the polarity reversal of the first common electrode voltage is delayed with respect to the polarity reversal of the second common electrode voltage; and the first common electrode voltage and the second common electrode voltage are simultaneously subjected to respective polarity reversals at the falling edge of the polarity reversal.

As a further aspect, the control means carries out the control so that the time difference is secured merely with respect to the (1); delay the polarity reversal of the second common electrode is delayed voltage with respect to the polarity reversal of the first common electrode voltage; and the first common electrode voltage and the second common electrode voltage are simultaneously subjected to respective polarity reversals at the falling edge of the polarity reversal.

As yet another aspect, in addition to the above arrangement, the control means carries out the control so that the time difference is secured merely with respect to the (2); delay the polarity reversal of the first common electrode voltage is delayed with respect to the polarity reversal of the second common electrode voltage at the falling edge of the polarity reversal; and the first common electrode voltage and the second common electrode voltage are simultaneously subjected to respective polarity reversals at the rising edge of the polarity reversal.

As another aspect, in addition to the above arrangement, the control means carries out the control so that the time difference is secured merely with respect to the (2); delay the polarity reversal of the second common electrode voltage is delayed with respect to the polarity reversal of the first common electrode voltage at the falling edge of the polarity reversal; and the first common electrode voltage and the second common electrode voltage are simultaneously subjected to respective polarity reversals at the rising edge of the polarity reversal.

The liquid crystal display device in accordance with the present invention can be such that, in addition to the above arrangement, the control means secures the time difference in response to a predetermined timing signal.

Especially, by using a timing signal (e.g., a clock signal (detailed later)) used in producing an image display as the predetermined timing signal, no separate clock signal needs to be provided to adjust the timing of the polarity reversal, and an existing circuit configuration can be used. The liquid crystal display device in accordance with the present invention can be realized without requiring a complex circuit configuration.

In addition, specifically, the liquid crystal display device in accordance with the present invention is preferably such that the timing signal is a clock signal which is outputted from an oscillator provided in the display device.

According to the arrangement, an existing circuit configuration can be used. The liquid crystal display device in accordance with the present invention can be realized without requiring a complex circuit configuration.

In addition, in place of the above arrangement, the liquid crystal display device in accordance with the present invention can be such that the timing signal is a clock signal which is supplied from an external device of the display device.

According to the arrangement, an existing circuit configuration can be used. The liquid crystal display device in accordance with the present invention can be realized without requiring a complex circuit configuration.

Furthermore, the liquid crystal display device in accordance with the present invention is preferably such that, in addition to the above arrangement, the time difference is equal to an integral multiple of half a cycle of the clock signal.

As early described, the liquid crystal display device in accordance with the present invention can be realized, with the use of a simple circuit configuration, in a case where a reversal timing is delayed by an integral multiple of half a cycle of the clock signal.

Furthermore, the liquid crystal display device in accordance with the present invention is preferably such that, in addition to the above arrangement, the time difference is equal to a delay time occurred when the clock signal has passed through a plurality of cascade-connected inverters or buffer circuits provided in the display device.

According to the above arrangement, an arrangement which delays a reversal timing can also be realized, with the use of a simple circuit configuration.

Furthermore, the liquid crystal display device in accordance with the present invention is preferably such that, in addition to the above arrangement, the time difference is not longer than a time period obtained by subtracting, from the given time period, a time period during which a voltage is applied to a gate electrode provided in the active element.

Should a writing (charging) period for a pixel overlap a reversing period for a common electrode voltage, charging can be insufficient. The specification of the time difference as above prevents the writing (charging) period for the pixel from overlapping the reversing period for the common electrode voltage, thereby preventing insufficient charging.

Furthermore, the liquid crystal display device in accordance with the present invention is preferably such that, in addition to the above arrangement, the control means controls in relation to a transition of the second common electrode voltage so that a transition period from a potential level immediately before the polarity reversal to a potential level upon completion of the polarity reversal is divided into a plurality of transition periods.

Furthermore, the liquid crystal display device in accordance with the present invention is preferably such that, in addition to the above arrangement, the control means controls so that the second common electrode voltage is equal to a potential level which the first common electrode voltage has immediately before the polarity reversal, in at least one of the plurality of transition periods, excluding a starting and an ending one of the plurality of transition periods.

In addition, the liquid crystal display device in accordance with the present invention, is preferably such that, in addition to the above arrangement, the control means controls so that each of the plurality of transition periods occurs at a timing which is different from a timing at which the first common electrode voltage undergoes the polarity reversal from a potential level immediately before the polarity reversal to a potential level upon completion of the polarity reversal.

Furthermore, the liquid crystal display device in accordance with the present invention is preferably such that, in addition to the above arrangement, the control means controls in relation to a transition of each of the first common electrode voltage and the second common electrode voltage so that a transition period from a potential level immediately before the polarity reversal to a potential level upon completion of the polarity reversal is divided into a plurality of transition periods.

Furthermore, the liquid crystal display device in accordance with the present invention is preferably such that, in addition to the above arrangement, the control means includes switching means for switching, in the given time period, between the (1), the (2), and both the (1) and (2).

Since the reversal cycles of individual COM1 and COM2 at the rising edge differ from those at the falling edge, the peak values of electric current in terms of frequency band can be lowered. Therefore, EMI can be more effectively restrained than the aforementioned aspect in which the reversal cycles of individual COM1 and COM2 at the rising edge are equal to those at the falling edge.

Furthermore, the liquid crystal display device in accordance with the present invention preferably, in addition to the above arrangement, is such that its operation mode is a VA mode.

According to the arrangement, wide viewing angle characteristics can be achieved.

Furthermore, the liquid crystal display device in accordance with the present invention can be such that, in addition to the above arrangement, the given time period is equal to an integral multiple of a horizontal scan period.

Furthermore, in place of the above arrangement, the given time period can be a blanking period of a vertical scan period.

The present invention is suitably applicable to various apparatus incorporating a liquid crystal display device in a display section, such as television sets and mobile terminals.

1. A liquid crystal display device, comprising:
an active matrix substrate on which a plurality of data signal lines and a plurality of scan signal lines which intersect with the plurality of data signal lines are provided, and a plurality of active elements and a plurality of pixel electrodes are provided at respective intersections of the plurality of data signal lines and the plurality of scan signal lines;
a counter substrate provided opposite the active matrix substrate;
a plurality of common electrodes provided on the active matrix substrate or the counter substrate, each of the plurality of common electrodes being made up of a first common electrode and a second common electrode, each of the plurality of pixel electrodes having (a) a region facing the first common electrode and (b) a region facing the second common electrode, the second common electrode being different from the first common electrode;
a liquid crystal layer provided between the active matrix substrate and the counter substrate;
first common electrode voltage application means for applying a first common electrode voltage to the first common electrode;
second common electrode voltage application means for applying a second common electrode voltage to the second common electrode, the second common electrode voltage being different from the first common electrode voltage; and
control means for controlling (i) the first common electrode voltage application means to apply the first common electrode voltage to the first common electrode so that the first common electrode voltage is subjected to a polarity reversal for each certain time period and (ii) the second common electrode voltage application means to apply the second common electrode voltage to the second common electrode so that the second common electrode voltage is subjected to a polarity reversal for each certain time period,
said control means carrying out control so that a time difference is secured, in a given time period, at least one of:
(1) between (a) a rising edge of a polarity reversal of a first common electrode voltage and (b) a rising edge of a polarity reversal of a second common electrode voltage, and
(2) between (c) a falling edge of a polarity reversal of the first common electrode voltage and (d) a falling edge of a polarity reversal of the second common electrode voltage,
where the rising edge of the polarity reversal indicates a time point at which the first or second common electrode voltage starts to rise from a first voltage to a second voltage which is larger than the first voltage, and the falling edge of the polarity reversal indicates a time point at which the first or second common electrode voltage starts to fall from a third voltage to a fourth voltage which is smaller than the third voltage.

2. The liquid crystal display device as set forth in claim 1, wherein:
the first common electrode voltage has an amplitude which is smaller than that of the second common electrode voltage; and
the time difference is secured by the control of said control means so that the polarity reversal of the first common electrode voltage is delayed with respect to the polarity reversal of the second common electrode voltage.

3. The liquid crystal display device as set forth in claim 1, wherein:
the first common electrode voltage has an amplitude which is smaller than that of the second common electrode voltage; and
the time difference is secured by the control of said control means so that the polarity reversal of the second common electrode voltage is delayed with respect to the polarity reversal of the first common electrode voltage.

4. The liquid crystal display device as set forth in claim 1, wherein:
said control means carries out the control so that the time difference is secured with respect to both of the (1) and (2); and
the time differences are secured by the control of said control means so that (i) the polarity reversal of the first common electrode voltage is delayed with respect to the polarity reversal of the second common electrode voltage at the rising edge of the polarity reversal and (ii) the polarity reversal of the second common electrode voltage is delayed with respect to the polarity reversal of the first common electrode voltage at the falling edge of the polarity reversal.

5. The liquid crystal display device as set forth in claim 1, wherein:
said control means carries out the control so that the time difference is secured with respect to both of the (1) and (2); and
the time differences are secured by the control of said control means so that (i) the polarity reversal of the second common electrode voltage is delayed with respect to the polarity reversal of the first common electrode voltage at the rising edge of the polarity reversal and (ii) the polarity reversal of the first common electrode voltage is delayed with respect to the polarity reversal of the second common electrode voltage at the falling edge of the polarity reversal.

6. The liquid crystal display device as set forth in claim 1, wherein:
said control means carries out the control so that the time difference is secured merely with respect to the (1);
the time difference is secured by the control of said control means so that the polarity reversal of the first common electrode voltage is delayed with respect to the polarity reversal of the second common electrode voltage; and
the first common electrode voltage and the second common electrode voltage are simultaneously subjected to respective polarity reversals at the falling edge of the polarity reversal.

7. The liquid crystal display device as set forth in claim 1, wherein
said control means carries out the control so that the time difference is secured merely with respect to the (1);
the time difference is secured by the control of said control means so that the polarity reversal of the second common electrode voltage is delayed with respect to the polarity reversal of the first common electrode voltage; and
the first common electrode voltage and the second common electrode voltage are simultaneously subjected to respective polarity reversals at the falling edge of the polarity reversal.

8. The liquid crystal display device as set forth in claim 1, wherein:
said control means carries out the control so that the time difference is secured merely with respect to the (2);
the time difference is secured by the control of said control means so that the polarity reversal of the first common electrode voltage is delayed with respect to the polarity reversal of the second common electrode voltage at the falling edge of the polarity reversal; and
the first common electrode voltage and the second common electrode voltage are simultaneously subjected to respective polarity reversals at the rising edge of the polarity reversal.

9. The liquid crystal display device as set forth in claim 1, wherein:
said control means carries out the control so that the time difference is secured merely with respect to the (2);
the time difference is secured by the control of said control means so that the polarity reversal of the second common electrode voltage is delayed with respect to the polarity reversal of the first common electrode voltage at the falling edge of the polarity reversal; and
the first common electrode voltage and the second common electrode voltage are simultaneously subjected to respective polarity reversals at the rising edge of the polarity reversal.

10. The liquid crystal display device as set forth in claim 1, wherein
said control means secures the time difference in response to a predetermined timing signal.

11. The liquid crystal display device as set forth in claim 10, wherein
the timing signal is a clock signal which is outputted from an oscillator provided in the display device.

12. The liquid crystal display device as set forth in claim 10, wherein
the timing signal is a clock signal which is supplied from an external device of the display device.

13. The liquid crystal display device as set forth in claim 11, wherein
the time difference is equal to an integral multiple of half a cycle of the clock signal.

14. The liquid crystal display device as set forth in claim 11, wherein
the time difference is equal to a delay time occurred when the clock signal has passed through a plurality of cascade-connected inverters or buffer circuits provided in the display device.

15. The liquid crystal display device as set forth in claim 1, wherein
the time difference is not longer than a time period obtained by subtracting, from the given time period, a time period during which a voltage is applied to a gate electrode provided in the active element.

16. The liquid crystal display device as set forth in claim 2, wherein
the control means controls in relation to a transition of the second common electrode voltage so that a transition period from a potential level immediately before the polarity reversal to a potential level upon completion of the polarity reversal is divided into a plurality of transition periods.

17. The liquid crystal display device as set forth in claim 16, wherein
the control means controls so that the second common electrode voltage is equal to a potential level which the first common electrode voltage has immediately before the polarity reversal, in at least one of the plurality of transition periods, excluding a starting and an ending one of the plurality of transition periods.

18. The liquid crystal display device as set forth in claim 16, wherein
the control means controls so that each of the plurality of transition periods occurs at a timing which is different from a timing at which the first common electrode voltage undergoes the polarity reversal from a potential level immediately before the polarity reversal to a potential level upon completion of the polarity reversal.

19. The liquid crystal display device as set forth in claim 2, wherein
the control means controls in relation to a transition of each of the first common electrode voltage and the second common electrode voltage so that a transition period from a potential level immediately before the polarity reversal to a potential level upon completion of the polarity reversal is divided into a plurality of transition periods.

20. The liquid crystal display device as set forth in claim 1, wherein
the control means includes switching means for switching, in the given time period, between the (1), the (2), and both the (1) and (2).

21. The liquid crystal display device as set forth in claim 1, wherein its operation mode is a VA mode.

22. The liquid crystal display device as set forth in claim 1, wherein
the given time period is equal to an integral multiple of a horizontal scan period.

23. The liquid crystal display device as set forth in claim 1, wherein
the given time period is a blanking period of a vertical scan period.
